(19) United States
(12) Patent Application Publication
(10) Pub. No.: US 2025/0202385 A1
(43) Pub. Date: Jun. 19, 2025

(54) CONTROL APPARATUS OF VIBRATION ACTUATOR, CONTROL METHOD FOR THE SAME, DRIVING APPARATUS, AND ELECTRONIC DEVICE

(71) Applicant: CANON KABUSHIKI KAISHA, Tokyo (JP)

(72) Inventors: HIROMITSU MORITA, Saitama (JP); Akio Atsuta, Kanagawa (JP); TAIGA NAGATA, Kanagawa (JP)

(21) Appl. No.: 19/066,028

(22) Filed: Feb. 27, 2025

Related U.S. Application Data
(63) Continuation of application No. PCT/JP2023/031669, filed on Aug. 31, 2023.

(30) Foreign Application Priority Data
Sep. 6, 2022 (JP) 2022-141283

(51) Int. Cl. H02N 2/14

(52) U.S. Cl. CPC H02N 2/142

(57) ABSTRACT

A control unit of a control apparatus for a vibration actuator is configured so that when the value of a speed deviation (first value) obtained by subtracting a current value from a command value related to the relative speed of a vibrating body and a contact body of the vibration actuator is positive at a certain time during acceleration of the vibration actuator, the control unit performs control to decrease a driving frequency of alternating-current signals or control to increase a pulse width of the alternating-current signals, and in a case where the value of the speed deviation (first value) is other than positive, the control unit performs control of the driving frequency of the alternating-current signals or control of the pulse width of the alternating-current signals that is performed at a time prior to the specific time.

### CROSS-REFERENCE TO RELATED APPLICATIONS

This application is a Continuation of International Patent Application No. PCT/JP2023/031669, filed Aug. 31, 2023, which claims the benefit of Japanese Patent Application No. 2022-141283, filed Sep. 6, 2022, both of which are hereby incorporated by reference herein in their entirety.

### BACKGROUND OF THE DISCLOSURE

### Field of the Disclosure

The present disclosure relates to a control apparatus of a vibration actuator, a control method for the same, and a driving apparatus and an electronic device including the control apparatus of a vibration actuator.

### Background Art

There is a vibration actuator that obtains driving force by applying alternating-current signals in inherent vibration modes of a vibrating body, which is formed by attaching an electrical-mechanical energy transducer to a vibrating member, to the vibrating body to generate vibration and frictionally drive a contact body pressed into contact with the vibrating body. Still cameras, video cameras, and the like using a vibration actuator for AF driving and zoom driving have been commercialized as driving apparatuses including such a vibration actuator.

Patent Literature 1 discusses a method for driving and controlling a vibration actuator, where control in a low-speed region is performed using a pulse width, and control in a high-speed region is performed using a driving frequency. In Patent Literature 1, the pulse width is increased at a predetermined gradient (constant amount of change per time) during acceleration until a predetermined speed is reached.

Patent Literature 2 discusses a method for driving and controlling a vibration actuator, where PID control is performed through position feedback or the like using deviations between the command positions and actual positions of a contact body (moving body) and a vibrating body.

### CITATION LIST

### Patent Literature

Patent Literature 1: Japanese Patent Application Laid-Open No. 2019-198199
Patent Literature 2: Japanese Patent Application Laid-Open No. 2011-234603

However, in a case where the vibration actuator drives a driving target of high inertia, such as a high-power zoom lens, the inventions discussed in the foregoing Patent Literature 1 and Patent Literature 2 have the following issues.

FIGS. 18A and 18B are diagrams illustrating a relationship between time and speed in the driving control of the vibration actuators discussed in Patent Literature 1 and Patent Literature 2. Specifically, in Patent Literature 1, there occur a sharp increase in speed 1812 immediately after activation and a large overshoot of the speed 1812 beyond a target speed 1811 as illustrated in FIG. 18A. As a result, in Patent Literature 1, the driving of the driving target by the vibration actuator may become unstable and the driving noise of the vibration actuator is loud. In Patent Literature 2, as illustrated in FIG. 18B, there occurs a sharp increase in speed 1822 due to a startup delay, and the speed 1822 fluctuates many times because operation parameters are frequently increased and decreased to follow a command speed 1821. As a result, even in Patent Literature 2, the driving of the driving target by the vibration actuator may become unstable and the driving noise of the vibration actuator is loud.

### SUMMARY OF THE DISCLOSURE

The present disclosure has been achieved in view of the foregoing issues, and it is an aspect thereof to provide a mechanism that can prevent unstable driving of a driving target by a vibration actuator and reduce driving noise of the vibration actuator.

According to the present disclosure, a control apparatus of a vibration actuator including a vibrating body and a contact body, the vibrating body including an electrical-mechanical energy transducer, the contact body being configured to contact the vibrating body, the vibrating body and the contact body being moved relative to each other by vibration generated in the vibrating body, includes control means for, in a case where a first value that is a value concerning a relative speed between the vibrating body and the contact body and obtained by subtracting a current value from a command value generated to approach a target value is positive at a specific time during acceleration of the vibration actuator, performing control to decrease a frequency of the alternating-current signal or control to increase an effective voltage of the alternating-current signal, and in a case where the first value is other than positive, performing control of the frequency of the alternating-current signal or control of the effective voltage of the alternating-current signal that is performed at a time prior to the specific time.

According to another aspect of the present disclosure, a control apparatus of a vibration actuator including a vibrating body and a contact body, the vibrating body including an electrical-mechanical energy transducer, the contact body being configured to contact the vibrating body, the vibrating body and the contact body being moved relative to each other by vibration generated in the vibrating body, includes control means for, in a case where a first value that is a value concerning a relative speed between the vibrating body and the contact body and obtained by subtracting a current value from a command value generated to approach a target value is positive at a specific time during deceleration of the vibration actuator, performing control to increase a frequency of the alternating-current signal or control to decrease an effective voltage of the alternating-current signal, and in a case where the first value is other than positive, performing control of the frequency of the alternating-current signal or control of the effective voltage of the alternating-current signal that is performed at a time prior to the specific time.

According to yet another aspect of the present disclosure, a control apparatus of a vibration actuator including a vibrating body and a contact body, the vibrating body including an electrical-mechanical energy transducer, the contact body being configured to contact the vibrating body, the vibrating body and the contact body being moved relative to each other by vibration generated in the vibrating body, includes control means for, in a case where a first value that is a value concerning a relative speed between the vibrating body and the contact body and obtained by subtracting a current value from a command value generated to approach a target value is positive at a specific time during acceleration of the vibration actuator, performing control to decrease a frequency of the alternating-current signal or control to increase a phase difference of the alternating-current signal, and in a case where the first value is other than positive, performing control of the frequency of the alternating-current signal or control of the phase difference of the alternating-current signal that is performed at a time prior to the specific time.

According to yet another aspect of the present disclosure, a control apparatus of a vibration actuator including a vibrating body and a contact body, the vibrating body including an electrical-mechanical energy transducer, the contact body being configured to contact the vibrating body, the vibrating body and the contact body being moved relative to each other by vibration generated in the vibrating body, includes control means for, in a case where a first value that is a value concerning a relative speed between the vibrating body and the contact body and obtained by subtracting a current value from a command value generated to approach a target value is positive at a specific time during deceleration of the vibration actuator, performing control to increase a frequency of the alternating-current signal or control to decrease a phase difference of the alternating-current signal, and in a case where the first value is other than positive, performing control of the frequency of the alternating-current signal or control of the phase difference of the alternating-current signal that is performed at a time prior to the specific time.

The present disclosure also includes control methods for a vibration actuator by the foregoing control apparatuses of a vibration actuator, and driving apparatuses and electronic devices including the foregoing control apparatuses of a vibration actuator.

Further features of the present disclosure will become apparent from the following description of exemplary embodiments with reference to the attached drawings.

### BRIEF DESCRIPTION OF THE DRAWINGS

FIG. 1 is an exploded view of a vibration actuator according to a first exemplary embodiment of the present disclosure.

FIG. 2 is a perspective view of the assembled vibration actuator according to the first exemplary embodiment of the present disclosure.

FIG. 3 is a diagram illustrating an example of a hardware configuration of a vibration driving apparatus according to the first exemplary embodiment of the present disclosure.

FIG. 4 is a diagram illustrating an example of a functional configuration of the vibration driving apparatus according to the first exemplary embodiment of the present disclosure.

FIG. 5 is a flowchart illustrating an example of a processing procedure of a method for controlling the vibration actuator by a control apparatus according to the first exemplary embodiment of the present disclosure.

FIG. 6 is a flowchart illustrating the first exemplary embodiment of the present disclosure, illustrating an example of a detailed processing procedure of acceleration control in step S104 of FIG. 5.

FIG. 7 is a diagram illustrating the first exemplary embodiment of the present disclosure, illustrating a relationship between the speed of the vibration actuator and the pulse width and driving frequency of alternating-current signals during the acceleration control in step S104 of FIG. 5.

FIG. 8 is a flowchart illustrating a second exemplary embodiment of the present disclosure, illustrating an example of a detailed processing procedure of deceleration control in step S108 of FIG. 5.

FIG. 9 is a diagram illustrating the second exemplary embodiment of the present disclosure, illustrating a relationship between the speed of the vibration actuator and the pulse width and driving frequency of the alternating-current signals during the deceleration control in step S108 of FIG. 5.

FIG. 10 is a diagram illustrating modifications of the first and second exemplary embodiments of the present disclosure, illustrating a relationship between the position, speed, and acceleration of the vibration actuator and the pulse width of the alternating-current signals.

FIG. 11 is a flowchart illustrating a third exemplary embodiment of the present disclosure, illustrating an example of a detailed processing procedure of control to increase the pulse width of the alternating-current signals in step S204 of FIG. 6.

FIG. 12 is a diagram illustrating the third exemplary embodiment of the present disclosure, illustrating a relationship between the speed of the vibration actuator and the pulse width and driving frequency of the alternating-current signals during the acceleration control in step S104 of FIG. 5.

FIG. 13 is a flowchart illustrating the third exemplary embodiment of the present disclosure, illustrating an example of a detailed processing procedure of control to decrease the driving frequency of the alternating-current signals in step S208 of FIG. 6.

FIG. 14 is a diagram illustrating the third exemplary embodiment of the present disclosure, illustrating a relationship between the speed of the vibration actuator and the pulse width and driving frequency of the alternating-current signals during the acceleration control in step S104 of FIG. 5.

FIG. 15A is a diagram illustrating a fourth exemplary embodiment of the present disclosure, illustrating a relationship between the pulse width of the alternating-current signals and the speed of the vibration actuator.

FIG. 15B is a diagram illustrating the fourth exemplary embodiment of the present disclosure, illustrating a relationship between a phase difference between the two-phase alternating-current signals and the speed of the vibration actuator.

FIG. 16 is a flowchart illustrating the fourth exemplary embodiment of the present disclosure, illustrating an example of a detailed processing procedure of the acceleration control in step S104 of FIG. 5.

FIG. 17 is a diagram illustrating a fifth exemplary embodiment of the present disclosure, illustrating a configuration example where an imaging apparatus is applied as an electronic device including the vibration driving apparatus according to the first, second, third, or fourth exemplary embodiment.

FIG. 18A is a diagram illustrating a relationship between time and speed in driving control of the vibration actuator discussed in Patent Literature 1.

FIG. 18B is a diagram illustrating a relationship between time and speed in driving control of the vibration actuator discussed in Patent Literature 2.

### DESCRIPTION OF THE EMBODIMENTS

Modes (exemplary embodiments) for carrying out the present disclosure will be described below with reference to the drawings.

### First Exemplary Embodiment

A first exemplary embodiment of the present disclosure will initially be described.

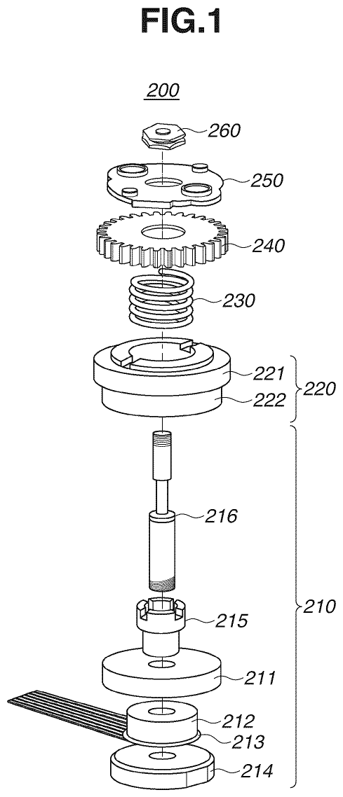

FIG. 1 is an exploded view of a vibration actuator 200 according to the first exemplary embodiment of the present disclosure.

As illustrated in FIG. 1, the vibration actuator 200 includes a vibrating body (may be referred to as a “vibrator”) 210, a rotating body 220, a coil spring 230, a gear 240, a fixing member 250, and an upper nut 260.

As illustrated in FIG. 1, the vibrating body 210 includes a first elastic body 211, a piezoelectric element (electrical-mechanical energy transducer) 212, a flexible substrate 213, a lower nut 214, a second elastic body 215, and a shaft 216. The first elastic body 211 is a plate (disc)-shaped elastic body formed of a material with low vibration damping loss, such as metal. The piezoelectric element 212 is an electrical-mechanical energy transducer. The flexible substrate 213 is a flexible substrate for applying alternating-current signals supplied from a driving power supply to the piezoelectric element 212. The lower nut 214 is a fastening member that fits to a screw portion formed at the bottom end of the shaft 216. The shaft 216 is inserted into through holes formed in the center portions of the first elastic body 211, the piezoelectric element 212, the flexible substrate 213, and the second elastic body 215. The shaft 216 has a step midway along its length, and this step abuts against a step on the inner wall of the second elastic body 215. The screw portion is formed at the end (bottom end) of the shaft 216. The second elastic body 215, the first elastic body 211, the piezoelectric element 212, and the flexible substrate 213 can be fixed by fitting and fastening the lower nut 214 to the screw portion.

As illustrated in FIG. 1, the rotating body 220 includes a moving body 221 and a contact spring 222. The contact spring 222 fixed to the moving body 221 is pressed into contact with the surface of the first elastic body 211 on the side not contacting the piezoelectric element 212. The contact spring 222 is a contact body that has elasticity and contacts the first elastic body 211 of the vibrating body 210, and is fixed to and rotates integrally with the moving body 221.

The coil spring 230 is a pressurizing means that is disposed between a spring receiving portion of the moving body 221 and the gear 240 and presses the moving body 221 down toward the first elastic body 211.

The gear 240 is an output means and fitted to the moving body 221 to allow movement of the moving body 221 in the rotation axis direction and rotate integrally with the moving body 221. The gear 240 is pivotally supported by the fixing member 250 coupled with the shaft 216. The axial position of the gear 240 is regulated by the fixing member 250.

A screw portion is also formed at the end (top end) of the shaft 216 on the side where the lower nut 214 is not fitted. The upper nut 260 is fitted to this screw portion to fix the shaft 216 to the fixing member 250. The fixing member 250 has screw holes, and the vibration actuator 200 can be attached to a desired location by fixing the fixing member 250 to the desired location using screws.

The piezoelectric element 212 has a driving electrode A (not illustrated) for generating a first bending vibration. Applying a predetermined alternating-current voltage (alternating-current signal) to this driving electrode A generates an A-mode vibration. The piezoelectric element 212 also has a driving electrode B (not-illustrated) for generating a second bending vibration 90° shifted in phase in the rotational direction with respect to the first bending vibration. Applying a predetermined alternating-current voltage (alternating-current signal) to this driving electrode B generates a B-mode vibration. Applying alternating-current voltages (alternating-current signals) having a frequency close to the resonant frequency of the vibrating body 210 and different phases to the driving electrodes A and B of the piezoelectric element 212 generates vibration that produces a force in the rotational direction on the first elastic body 211. Here, an elliptic motion composed of a motion in a vertical direction (the axial direction of the vibrating body 210) orthogonal to the rotational direction and a motion in the rotational direction (lateral direction) occurs at each position on the first elastic body 211 in the driving direction. With the contact spring 222 pressed into contact with the surface of the first elastic body 211 where the elliptic motion is excited, the contact spring 222 and the moving body 221 (rotating body 220) are moved by the driving force from the elliptic motion. In other words, the vibration actuator 200 according to the present exemplary embodiment moves the vibrating body 210 and the contact spring 222 that is the contact body relative to each other using the vibration generated by the application of the alternating-current signals to the piezoelectric element (electrical-mechanical energy transducer) 212.

In the case of using such a vibration actuator 200 to drive, e.g., a camera lens, constant speed control to drive the lens at a constant speed in a stable state is desired of the vibration actuator 200 since the lens needs to be driven smoothly.

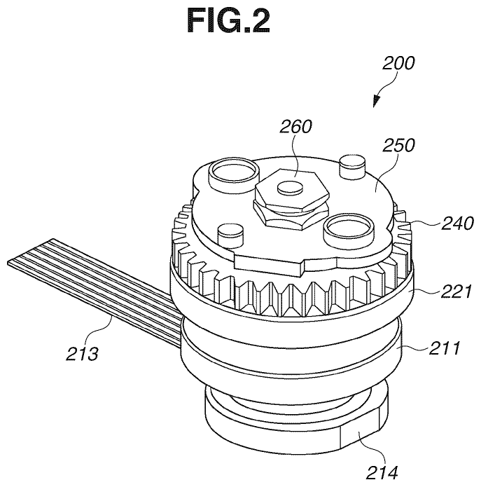

FIG. 2 is a perspective view of the assembled vibration actuator 200 according to the first exemplary embodiment of the present disclosure. In this FIG. 2, components similar to those illustrated in FIG. 1 are denoted by the same reference numerals.

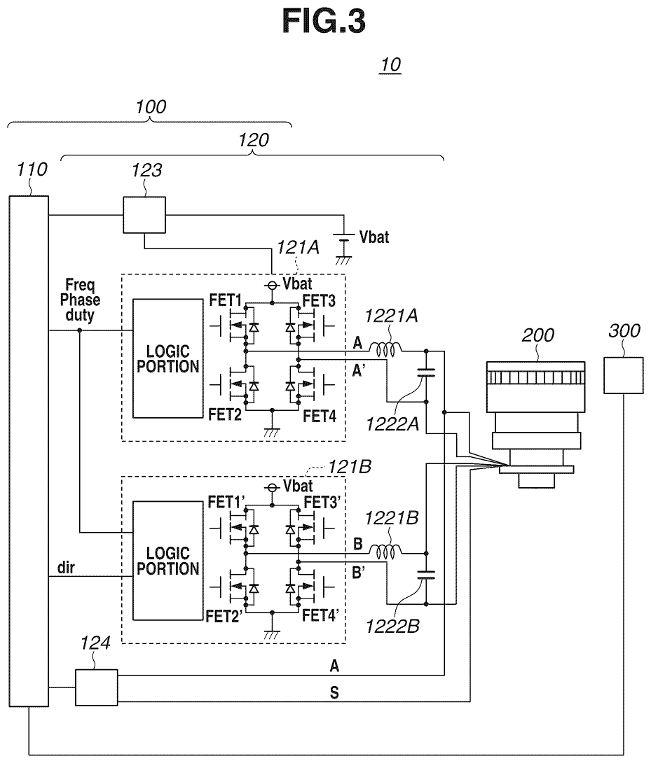

FIG. 3 is a diagram illustrating an example of a hardware configuration of a vibration driving apparatus 10 according to the first exemplary embodiment of the present disclosure. In this FIG. 3, components similar to those illustrated in FIGS. 1 and 2 are denoted by the same reference numerals. As illustrated in FIG. 3, the vibration driving apparatus 10 includes a control apparatus 100 of a vibration actuator, the vibration actuator 200, and a position detection unit 300.

As illustrated in FIG. 3, the control apparatus 100 of a vibration actuator (hereinafter, referred to simply as “control apparatus 100”) includes a control unit 110 and a driving unit 120. The driving unit 120 includes alternating-current signal generation units 121A and 121B, coils 1221A and 1221B, capacitors 1222A and 1222B, a power supply voltage detection unit 123, and a phase difference detection unit 124.

The control unit 110 includes a microcomputer, for example, and controls operation of the vibration driving apparatus 10 in a comprehensive manner.

The alternating-current signal generation unit 121A generates an alternating-current signal that is a driving signal in a first mode (A-mode) based on command values from the control unit 110. The alternating-current signal generation unit 121B generates an alternating-current signal that is a driving signal in a second mode (B-mode) based on command values from the control unit 110. The alternating-current signal generation units 121A and 121B can change a phase difference between the alternating-current signals in A- and B-modes within the range of 0° to 360°. The alternating-current signal generation unit 121A is a switching circuit that switches the power supply voltage (Vbat) of an A-mode signal using FET1 to FET4 that are switching elements. The alternating-current signal generation unit 121A amplifies its switching voltage through a step-up effect of the combination of the coil 1221A and the capacitor 1222A, and applies the amplified switching voltage to an A-mode driving terminal of the vibration actuator 200. The alternating-current signal generation unit 121B is a switching circuit that switches the power supply voltage (Vbat) of a B-mode signal using FET1′ to FET4′ that are switching elements. The alternating-current signal generation unit 121B amplifies its switching voltage through a step-up effect of the combination of the coil 1221B and the capacitor 1222B, and applies the amplified switching voltage to a B-mode driving terminal of the vibration actuator 200.

The power supply voltage detection unit 123 detects the magnitude of the power supply voltage (Vbat). The power supply that generates the power supply voltage (Vbat) is connected to the power supply voltage detection unit 123, and switching pulses are generated by switching the power supply voltage (Vbat).

As employed herein, a driving frequency refers to the frequency of the switching by the alternating-current signal generation units 121A and 121B, and is output as switching pulses from terminals A and A′ of the alternating-current signal generation unit 121A and terminals B and B′ of the alternating-current signal generation unit 121B. A pulse width refers to the time width of the switching pulses output from the alternating-current signal generation units 121A and 121B. If on and off time widths are 1:1, the pulse width is referred to as duty 50%. If the on and off time widths are 1:3, the pulse width is referred to as duty 25%. Control to change the speed of the vibration actuator 200 by changing this time width will be referred to as pulse width control.

The phase difference detection unit 124 is a component that detects a phase difference between an applied voltage and a voltage detected from the vibration actuator 200 to monitor a resonance state.

The position detection unit 300 is a component that detects the rotational position of the rotating body 220 of the vibration actuator 200. Information about the position and speed of the rotating body 220 is transmitted to the control unit 110 based on the result obtained by the position detection unit 300. The control unit 110 controls the rotational position and rotation speed of the vibration actuator 200 based on the received information about the position and speed of the rotating body 220 of the vibration actuator 200.

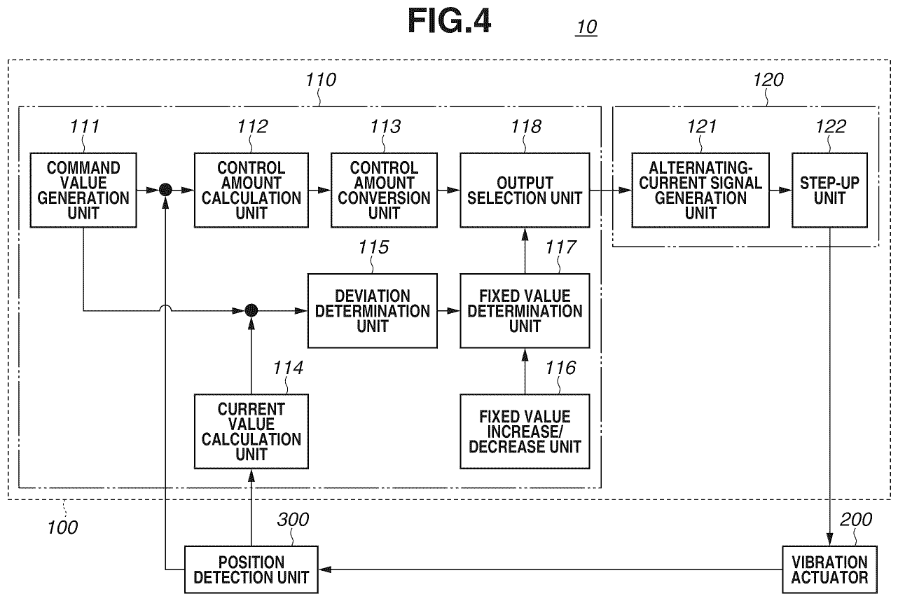

FIG. 4 is a diagram illustrating an example of a functional configuration of the vibration driving apparatus 10 according to the first exemplary embodiment of the present disclosure. In this FIG. 4, components similar to those illustrated in FIG. 3 are denoted by the same reference numerals.

As illustrated in FIG. 4, the driving unit 120 includes an alternating-current signal generation unit 121 and a step-up unit 122. Here, the alternating-current signal generation unit 121 illustrated in FIG. 4 includes the alternating-current signal generation units 121A and 121B illustrated in FIG. 3. The step-up unit 122 illustrated in FIG. 4 includes the coils 1221A and 1221B and the capacitors 1222A and 1222B illustrated in FIG. 3. In the driving unit 120 illustrated in FIG. 4, the power supply voltage detection unit 123 and the phase difference detection unit 124 illustrated in FIG. 3 are omitted.

The control apparatus 100 includes the control unit 110 and the driving unit 120.

As illustrated in FIG. 4, the control unit 110 includes a command value generation unit 111, a control amount calculation unit 112, a control amount conversion unit 113, a current value calculation unit 114, a deviation determination unit 115, a fixed value increase/decrease unit 116, a fixed value determination unit 117, and an output selection unit 118. The components 111 to 118 constituting the control unit 110 perform specific operations based on output (control signals). As described above, the control unit 110 includes a microcomputer, for example. Here, the control unit 110 includes electrical parts such as an arithmetic unit (CPU), a memory storing programs, and a memory serving as a work area for loading programs, and generates signals having information for controlling the driving of the vibration actuator 200.

The command value generation unit 111 generates command values to approach a target value. Specifically, as the command values, the command value generation unit 111 generates a command position and a command speed for moving the vibration actuator 200 to the target value. Here, the command position refers to position information for moving the vibration actuator 200 to a target position that changes with time, and is set to perform position control for moving the vibration actuator 200 to a final stop position. In the present exemplary embodiment, the command values generated by the command value generation unit 111 can be interpreted and applied as referring to a target value that changes with time.

A signal related to a deviation between the command position that is an output of the command value generation unit 111 and the position that is the output of the position detection unit 300 is input to the control amount calculation unit 112. Using this deviation-related signal, the control amount calculation unit 112 calculates the control amount of the vibration actuator 200 by, e.g., PID calculation.

The control amount output from the control amount calculation unit 112 is input to the control amount conversion unit 113. The control amount conversion unit 113 converts the control amount output from the control amount calculation unit 112 into a pulse width or a driving frequency.

Position information that is the output of the position detection unit 300 is input to the current value calculation unit 114. The current value calculation unit 114 calculates an actual speed as the current value from the value obtained from the position detection unit 300.

The command speed that is a command value output from the command value generation unit 111 and the actual speed that is the current value output from the current value calculation unit 114 are input to the deviation determination unit 115. The deviation determination unit 115 determines the sign (positive or not, etc.) of a signal related to a deviation between the command speed output from the command value generation unit 111 and the actual speed output from the current value calculation unit 114.

The fixed value increase/decrease unit 116 increases or decreases a pulse width or driving frequency that is a fixed value.

The output of the deviation determination unit 115 and the output of the fixed value increase/decrease unit 116 are input to the fixed value determination unit 117. The fixed value determination unit 117 determines the foregoing fixed value based on the determination result of the deviation determination unit 115. For example, if the determination made by the deviation determination unit 115 is positive, the fixed value determination unit 117 determines the pulse width or driving frequency increased or decreased by the fixed value increase/decrease unit 116 as the fixed value. For example, if the determination made by the deviation determination unit 115 is other than positive, the fixed value determination unit 117 determines the pulse width or driving frequency at a time prior to the time when the fixed value increase/decrease unit 116 increases or decreases the fixed value as the fixed value. As employed herein, the prior time refers to one control cycle before (immediately before) the current control cycle.

The output of the control amount conversion unit 113 and the output of the fixed value determination unit 117 are input to the output selection unit 118. The output selection unit 118 selects between the outputs depending on whether the actual speed that is the current value of the vibration actuator 200 reaches the command speed that is the command value. For example, if the actual speed does not reach the command speed, the output selection unit 118 inputs the output of the fixed value determination unit 117 to the alternating-current signal generation unit 121. If the target speed has been reached, the output selection unit 118 outputs the output of the control amount conversion unit 113 to the alternating-current signal generation unit 121. Here, to ensure continuity of the pulse width or driving frequency output to the alternating-current signal generation unit 121, the output selection unit 118 may add a difference between the output of the control amount conversion unit 113 and the output of the fixed value determination unit 117 to the output of the control amount conversion unit 113 and output the result.

The output of the output selection unit 118 is input to the alternating-current signal generation unit 121. This alternating-current signal generation unit 121 is a driver circuit or the like that generates alternating-current signals through switching, for example. Specifically, in controlling the vibration actuator 200 in a low-speed range, the alternating-current signal generation unit 121 generates two-phase alternating-current signals that have the pulse width output from the output selection unit 118 and a driving frequency set to a maximum value, for example. The driving frequency set to the maximum value refers to the frequency set to the highest value or a value nearby in the driving frequency band used to drive the vibration actuator 200. On the other hand, in controlling the vibration actuator 200 in a high-speed range, the alternating-current signal generation unit 121 generates two-phase alternating-current signals that have the driving frequency output from the output selection unit 118 and a pulse width set to a maximum value (such as 50%), for example. The sign of the phase difference between the two-phase alternating-current signals generated by the alternating-current signal generation unit 121 is set based on the driving direction. For example, the sign is set like +90° for a forward direction, and −90° for a reverse direction.

The output of the alternating-current signal generation unit 121 is input to the step-up unit 122. The step-up unit 122 steps up the two-phase alternating-current signals generated by the alternating-current signal generation unit 121 through switching, and applies the resulting signals to the vibration actuator 200.

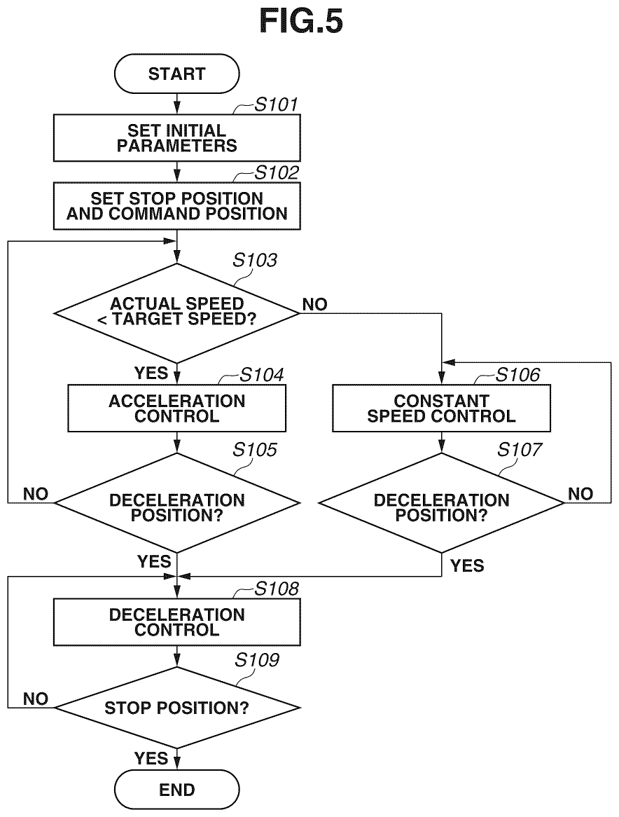

FIG. 5 is a flowchart illustrating an example of a processing procedure of a method for controlling the vibration actuator 200 by the control apparatus 100 according to the first exemplary embodiment of the present disclosure. The processing steps of the flowchart illustrated in FIG. 5 are implemented, for example, by the CPU of the control unit 110 loading a predetermined program stored in the memory and controlling operation of the components of the control apparatus 100.

When the vibration driving apparatus 10 is powered on, in step S101, the control unit 110 initially sets initial parameters. Specifically, as the initial parameters, the control unit 110 sets the phase difference, frequency, and pulse width of the alternating-current signals to be applied to the piezoelectric element (electrical-mechanical energy transducer) 212 of the vibration actuator 200 to their initial values. Here, the phase difference between the alternating-current signals may be gradually increased from 0° to a maximum value, for example. However, this is not restrictive, and the phase difference may start at a value other than 0.

Next, in step S102, the control unit 110 (for example, the command value generation unit 111) sets a stop position that is the position for the vibration actuator 200 to finally stop at and a command position for moving the vibration actuator 200 to a target position that changes with time based on the stop position. Here, the command position is set for each time interval (for example, every Δt) to implement an acceleration period where the vibration actuator 200 is accelerated, a constant speed period where the vibration actuator 200 remains at the target speed, and a deceleration period where the vibration actuator 200 is decelerated, for example. However, this is not restrictive. For example, depending on the distance, the command position may be set to implement the acceleration period and the deceleration period without the constant speed period.

Next, in step S103, the control unit 110 determines whether the actual speed calculated by the current value calculation unit 114 is lower than the target speed.

If, as a result of the determination in step S103, the actual speed is lower than the target speed (YES in step S103), the processing proceeds to step S104.

In step S104, the control unit 110 performs acceleration control of the vibration actuator 200. Details of the acceleration control in this step S104 will be described below.

Once a single control cycle of the acceleration control in step S104 ends, then in step S105, the control unit 110 determines whether the vibration actuator 200 is at a deceleration position (has reached the deceleration position). If, as a result of this determination, the vibration actuator 200 is not at the deceleration position (has not reached the deceleration position) (NO in step S105), the processing returns to step S103, and the control unit 110 performs the processing of steps S103 onward.

On the other hand, if, as a result of the determination in step S103, the actual speed is not lower than the target speed (the actual speed has reached the target speed) (NO in step S103), the processing proceeds to step S106.

In step S106, the control unit 110 performs constant speed control of the vibration actuator 200. In this constant speed control, the control unit 110 calculates a deviation between the command position at each time (for example, every Δt) set in step S102 and the actual position detected by the position detection unit 300, for example, and calculates the control amounts of the driving frequency and pulse width of the alternating-current signals through PID calculation, for example. The control unit 110 then performs frequency control with a constant pulse width in the high-speed range of the vibration actuator 200 or performs pulse width control with a constant driving frequency in the low-speed range, for example, to implement the target speed based on the calculated control amounts. Here, control to change at least one of the driving frequency and pulse width of the alternating-current signals can be performed. In the present exemplary embodiment, the constant speed control is described to be performed based on the deviation between the command position that is the command value concerning the position of the vibration actuator 200 and the actual position that is the current value. However, the present disclosure is not limited to such a mode. For example, a mode of performing the constant speed control based on a deviation between the command speed that is the command value concerning the speed of the vibration actuator 200 and the actual speed that is the current value is also applicable to the present disclosure.

Once a single control cycle of the constant speed control in step S106 ends, then in step S107, the control unit 110 determines whether the vibration actuator 200 is at the deceleration position (has reached the deceleration position). If, as a result of this determination, the vibration actuator 200 is not at the deceleration position (has not reached the deceleration position) (NO in step S107), the processing returns to step S106 and the control unit 110 performs the processing of steps S106 onward.

If the vibration actuator 200 is determined to be at the deceleration position (has reached the deceleration position) in step S105 (YES in step S105) or determined to be at the deceleration position (has reached the deceleration position) in step S107 (YES in step S107), the processing proceeds to step S108.

In step S108, the control unit 110 performs deceleration control of the vibration actuator 200. Like the foregoing constant speed control in step S106, this deceleration control is performed by calculating the control amounts of the driving frequency and pulse width of the alternating-current signals from the deviation between the command position and the actual position through PID calculation, for example, and controlling the vibration actuator 200 to decelerate toward the stop position set in step S102.

Next, in step S109, the control unit 110 determines whether the vibration actuator 200 is at the stop position set in step S102 (has reached the stop position). If, as a result of this determination, the vibration actuator 200 is not at the stop position (has not reached the stop position) (NO in step S109), the processing returns to step S108 and the control unit 110 performs the processing of steps S108 onward.

On the other hand, if, as a result of the determination in step S109, the vibration actuator 200 is at the stop position (has reached the stop position) (YES in step S109), the control unit 110 gradually reduces the pulse width of the alternating-current signals toward 0, for example, and ends driving the vibration actuator 200. The processing of the flowchart illustrated in FIG. 5 is thereby completed.

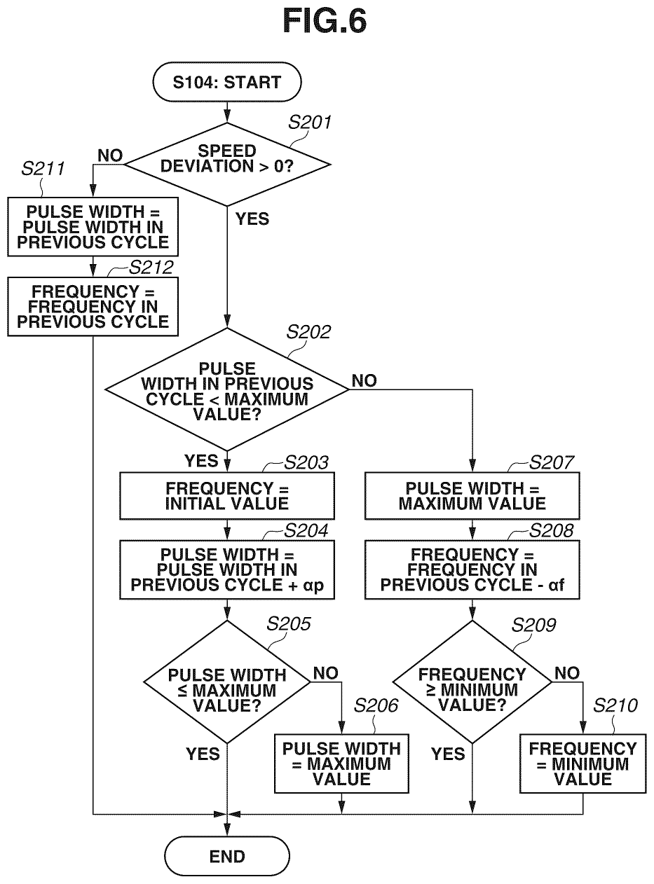

FIG. 6 is a flowchart illustrating the first exemplary embodiment of the present disclosure, illustrating an example of a detailed processing procedure of the acceleration control in step S104 of FIG. 5. Specifically, FIG. 6 illustrates the process of one control cycle of the acceleration control in step S104 of FIG. 5 from start to end.

When the acceleration control in step S104 of FIG. 5 is started, then in step S201 of FIG. 6, the control unit 110 initially determines whether the value of a speed deviation obtained by subtracting the actual speed calculated by the current value calculation unit 114 from the command speed generated by the command value generation unit 111 is positive. The processing of this step S201 is performed by the deviation determination unit 115 of the control unit 110, for example. In the present exemplary embodiment, the value of the speed deviation in step S201 corresponds to a “first value” that is a value concerning a relative speed between the vibrating body 210 and the contact spring 222 and obtained by subtracting the current value from the command value generated to approach the target value at a specific time during acceleration of the vibration actuator 200.

If, as a result of the determination in step S201, the value of the speed deviation is positive (YES in step S201), the processing proceeds to step S202.

In step S202, the control unit 110 determines whether the pulse width of the alternating-current signals in the previous control cycle is less than the maximum value.

If, as a result of the determination in step S202, the pulse width of the alternating-current signals in the previous control cycle is less than the maximum value (YES in step S202), the processing proceeds to step S203.

In step S203, the control unit 110 sets the driving frequency of the alternating-current signals to an initial value.

Next, in step S204, the control unit 110 sets the value obtained by adding αp to the pulse width of the alternating-current signals in the previous control cycle as the pulse width of the alternating-current signals. This αp is the amount of increase in the pulse width of the alternating-current signals in one control cycle.

Next, in step S205, the control unit 110 determines whether the pulse width of the alternating-current signals is less than or equal to the maximum value.

If, as a result of the determination in step S205, the pulse width of the alternating current is not less than or equal to the maximum value (the pulse width is greater than the maximum value) (NO in step S205), the processing proceeds to step S206.

In step S206, the control unit 110 sets the pulse width of the alternating-current signals to the maximum value.

If, as a result of the determination in step S202, the pulse width of the alternating-current signals in the previous control cycle is not less than the maximum value (the pulse width in the previous control cycle is greater than or equal to the maximum value) (NO in step S202), the processing proceeds to step S207.

In step S207, the control unit 110 sets the pulse width of the alternating-current signals to the maximum value.

Next, in step S208, the control unit 110 sets the value obtained by subtracting αf from the driving frequency of the alternating-current signals in the previous control cycle as the driving frequency of the alternating-current signals. This αf is the amount of decrease in the driving frequency of the alternating-current signals in one control cycle.

Next, in step S209, the control unit 110 determines whether the driving frequency of the alternating-current signals is higher than or equal to a minimum value.

If, as a result of the determination in step S209, the driving frequency of the alternating-current signals is not higher than or equal to the minimum value (the driving frequency is lower than the minimum value) (NO in step S209), the processing proceeds to step S210.

In step S210, the control unit 110 sets the driving frequency of the alternating-current signals to the minimum value.

If, as a result of the determination in step S201, the value of the speed deviation is not positive (the value of the speed deviation is other than positive) (NO in step S201), the processing proceeds to step S211.

In step S211, the control unit 110 sets the pulse width of the alternating-current signals to that of the alternating-current signals at the time of the previous control cycle immediately preceding this control cycle.

Next, in step S212, the control unit 110 sets the driving frequency of the alternating-current signals to that of the alternating-current signals at the time of the previous control cycle immediately preceding this control cycle.

If the determination in step S205 is yes (YES in step S205), if the processing of step S206 ends, if the determination in step S209 is yes (YES in step S209), if the processing of step S210 ends, or if the processing of step S212 ends, the processing of FIG. 6 ends. In other words, the acceleration control processing illustrated in FIG. 6 at a specific time in a control cycle where the vibration actuator 200 is accelerating ends.

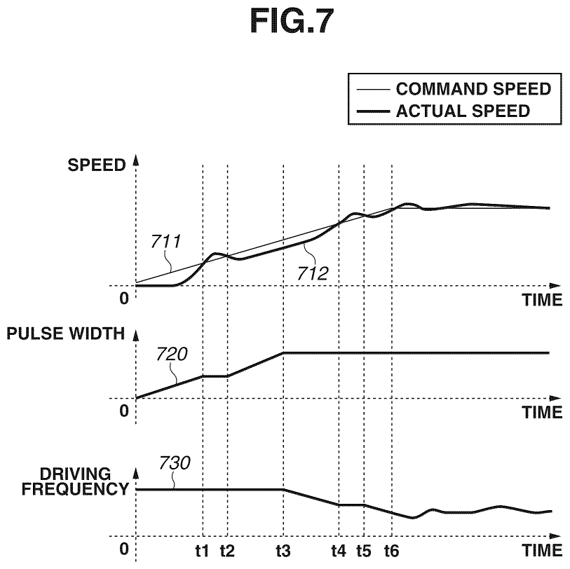

FIG. 7 is a diagram illustrating the first exemplary embodiment of the present disclosure, illustrating a relationship between the speed of the vibration actuator 200 and the pulse width and driving frequency of the alternating-current signals during the acceleration control in step S104 of FIG. 5. Specifically, FIG. 7 illustrates a command speed 711 and an actual speed 712 concerning the speed of the vibration actuator 200, a pulse width 720 of the alternating-current signals, and a driving frequency 730 of the alternating-current signals.

In FIG. 7, in the period from a start (time 0) to time t1 of the control cycle subsequent to time 0, the value of the speed deviation obtained by subtracting the actual speed 712 from the command speed 711 is positive. In this period, the pulse width 720 of the alternating-current signals increases gradually. This processing corresponds to the processing of step S204 in FIG. 6.

In FIG. 7, in the period from time t1 to time t2 of the control cycle subsequent to time t1, the value of the speed deviation obtained by subtracting the actual speed 712 from the command speed 711 is not positive. In this period, the pulse width 720 of the alternating-current signals remains at the same value as the pulse width of the alternating-current signals at time t1. This processing corresponds to the processing of step S211 in FIG. 6.

In FIG. 7, for example, in the period from time t3 to time t4, the pulse width 720 of the alternating-current signals is at the maximum value. In this period, the driving frequency 730 of the alternating-current signals decreases gradually. This processing corresponds to the processing of steps S207 and S208 in FIG. 6.

In FIG. 7, in the period from time t4 to time t5 of the control cycle subsequent to time t4, the value of the speed deviation obtained by subtracting the actual speed 712 from the command speed 711 is not positive. In this period, the driving frequency 730 of the alternating-current signals remains at the same value as the driving frequency of the alternating-current signals at time t4. This processing corresponds to the processing of step S212 in FIG. 6.

In the present exemplary embodiment, whether the value of the speed deviation is positive is described to be determined in step S201 of FIG. 6. However, the value is not limited to positive ones. For example, a range of values determined by actual measurement in advance may be used.

In the control apparatus 100 according to the first exemplary embodiment described above, the control unit 110 performs the following processing at a specific time during acceleration of the vibration actuator. If the value of the speed deviation (first value) obtained by subtracting the current value from the command value concerning the relative speed between the vibrating body 210 and the contact spring 222 is positive, the control unit 110 performs the control to decrease the driving frequency of the alternating-current signals (step S208) or the control to increase the pulse width of the alternating-current signals (step S204). Here, the control to increase the pulse width of the alternating-current signals (step S204) is equivalent to control to increase the effective voltage of the alternating-current signals. If the foregoing value of the speed deviation (first value) is other than positive, the control unit 110 performs the control of the driving frequency of the alternating-current signals (step S212) or the control of the pulse width of the alternating-current signals (step S211) that is performed at the time prior to the specific time.

In such a manner, the driving frequency and pulse width of the alternating-current signals are controlled depending on the sign of the value of the speed deviation, whereby a sharp increase in speed and speed fluctuations during the acceleration of the vibration actuator 200 can be prevented. This can prevent unstable driving of the driving target by the vibration actuator 200 and reduce driving noise of the vibration actuator 200.

In the present exemplary embodiment, the driving control of the vibration actuator 200 is performed using the pulse width and driving frequency of the alternating-current signals. However, similar effects can be obtained by using voltage control for controlling the voltage to be switched instead of the pulse width control of the alternating-current signals.

### Second Exemplary Embodiment

Next, a second exemplary embodiment will be described. In the following description of the second exemplary embodiment, a description of items common to the foregoing first exemplary embodiment will be omitted, and differences from the foregoing first exemplary embodiment will be mainly described.

A hardware configuration of a vibration driving apparatus according to the second exemplary embodiment is similar to that of the vibration driving apparatus 10 according to the first exemplary embodiment illustrated in FIG. 3. A functional configuration of the vibration driving apparatus 10 according to the second exemplary embodiment is similar to that of the vibration driving apparatus 10 according to the first exemplary embodiment illustrated in FIG. 4. The processing procedure of a method for controlling the vibration actuator 200 by the control apparatus 100 according to the second exemplary embodiment is similar to that of the method for controlling the vibration actuator 200 by the control apparatus 100 according to the first exemplary embodiment illustrated in FIG. 5.

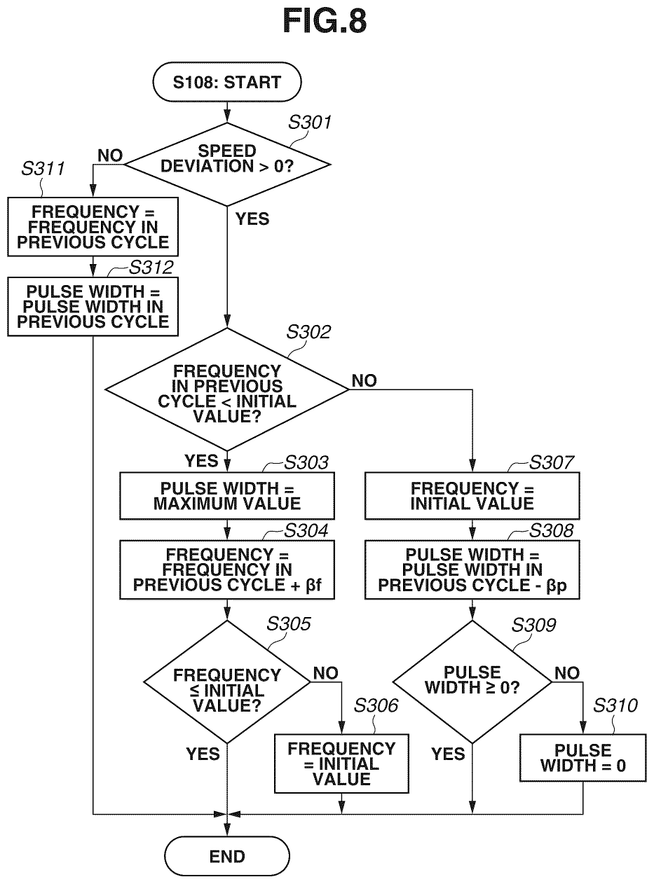

FIG. 8 is a flowchart illustrating the second exemplary embodiment of the present disclosure, illustrating an example of a detailed processing procedure during deceleration control in step S108 of FIG. 5. Specifically, FIG. 8 illustrates the process of one control cycle of the deceleration control in step S108 of FIG. 5 from start to end.

When the deceleration control in step S108 of FIG. 5 is started, then in step S301 of FIG. 8, the control unit 110 initially determines whether the value of the speed deviation obtained by subtracting the actual speed calculated by the current value calculation unit 114 from the command speed generated by the command value generation unit 111 is positive. The processing of this step S301 is performed by the deviation determination unit 115 of the control unit 110, for example. In the present exemplary embodiment, the value of the speed deviation in step S301 corresponds to the “first value” that is a value concerning the relative speed between the vibrating body 210 and the contact spring 222 and obtained by subtracting the current value from the command value generated to approach the target value at a specific time during deceleration of the vibration actuator 200.

If, as a result of the determination in step S301, the value of the speed deviation is positive (YES in step S301), the processing proceeds to step S302.

In step S302, the control unit 110 determines whether the driving frequency of the alternating-current signals in the previous control cycle is lower than the initial value.

If, as a result of the determination in step S302, the driving frequency of the alternating-current signals in the previous control cycle is lower than the initial value (YES in step S302), the processing proceeds to step S303.

In step S303, the control unit 110 sets the pulse width of the alternating-current signals to the maximum value.

Next, in step S304, the control unit 110 sets the value obtained by adding Bf to the driving frequency of the alternating-current signals in the previous control cycle as the driving frequency of the alternating-current signals. This Bf is the amount of increase in the driving frequency of the alternating-current signals in one control cycle.

Next, in step S305, the control unit 110 determines whether the driving frequency of the alternating-current signals is lower than or equal to the initial value.

If, as a result of the determination in step S305, the driving frequency of the alternating-current signals is not lower than or equal to the initial value (the driving frequency is higher than the initial value) (NO in step S305), the processing proceeds to step S306.

In step S306, the control unit 110 sets the driving frequency of the alternating-current signals to the initial value.

If, as a result of the determination in step S302, the driving frequency of the alternating-current signals in the previous control cycle is not lower than the initial value (the driving frequency of the alternating-current signals in the previous control cycle is higher than or equal to the initial value) (NO in step S302), the processing proceeds to step S307.

In step S307, the control unit 110 sets the driving frequency of the alternating-current signals to the initial value.

Next, in step S308, the control unit 110 sets the value obtained by subtracting Bp from the pulse width of the alternating-current signals in the previous control cycle as the pulse width of the alternating-current signals. This Bp is the amount of decrease in the pulse width of the alternating-current signals in one control cycle.

Next, in step S309, the control unit 110 determines whether the pulse width of the alternating-current signals is greater than or equal to 0.

If, as a result of the determination in step S309, the pulse width of the alternating-current signals is not greater than or equal to 0 (the pulse width is less than 0) (NO in step S309), the processing proceeds to step S310.

In step S310, the control unit 110 sets the pulse width of the alternating-current signals to 0.

If, as a result of the determination in step S301, the value of the speed deviation is not positive (the value of the speed deviation is other than positive) (NO in step S301), the processing proceeds to step S311.

In step S311, the control unit 110 sets the driving frequency of the alternating-current signals to that of the alternating-current signals at the time of the previous control cycle immediately preceding this control cycle.

Next, in step S312, the control unit 110 sets the pulse width of the alternating-current signals to that of the alternating-current signals at the time of the previous control cycle immediately preceding this control cycle.

If the determination in step S305 is yes (YES in step S305), if the processing of step S306 ends, if the determination in step S309 is yes (YES in step S309), if the processing of step S310 ends, or if the processing of step S312 ends, the processing of FIG. 8 ends. In other words, the deceleration control process shown in FIG. 8 ends at a specific point in the control cycle during which the vibration actuator 200 is decelerating.

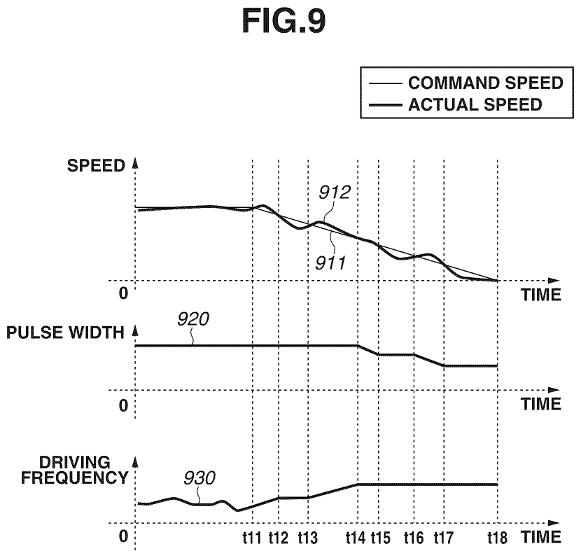

FIG. 9 is a diagram illustrating the second exemplary embodiment of the present disclosure, illustrating a relationship between the speed of the vibration actuator 200 and the pulse width and driving frequency of the alternating-current signals during the deceleration control in step S108 of FIG. 5. Specifically, FIG. 9 illustrates a command speed 911 and an actual speed 912 concerning the speed of the vibration actuator 200, a pulse width 920 of the alternating-current signals, and a driving frequency 930 of the alternating-current signals.

In FIG. 9, in the period from time t11 to time t12 of the control cycle subsequent to time t11, the driving frequency 930 of the alternating-current signals increases gradually. This processing corresponds to the processing of step S304 in FIG. 8.

In FIG. 9, in the period from time t12 to time t13 of the control cycle subsequent to time t12, the driving frequency 930 of the alternating-current signals remains at the same value as the driving frequency of the alternating-current signals at time t12. This processing corresponds to the processing of step S311 in FIG. 8.

In FIG. 9, for example, in the period from t14 to time t15, the driving frequency 930 of the alternating-current signals is at the initial value, and the pulse width 920 of the alternating-current signals decreases gradually. This processing corresponds to the processing of steps S307 and S308 of FIG. 8.

In FIG. 9, in the period from time t15 to time t16 of the control cycle subsequent to time t15, the pulse width 920 of the alternating-current signals remains at the same value as the pulse width of the alternating-current signals at time t15. This processing corresponds to the processing of step S312 in FIG. 8.

In the present exemplary embodiment, whether the value of the speed deviation is positive is described to be determined in step S301 of FIG. 8. However, the value is not limited to positive ones. For example, a range of values determined by actual measurement in advance may be used.

In the control apparatus 100 according to the second exemplary embodiment described above, the control unit 110 performs the following processing at a specific time during deceleration of the vibration actuator. If the value of the speed deviation (first value) obtained by subtracting the current value from the command value concerning the relative speed between the vibrating body 210 and the contact spring 222 is positive, the control unit 110 performs control to increase the driving frequency of the alternating-current signals (step S304) or control to decrease the pulse width of the alternating-current signals (step S308). Here, the control to decrease the pulse width of the alternating-current signals (step S308) is equivalent to control to decrease the effective voltage of the alternating-current signals. If the foregoing value of the speed deviation (first value) is other than positive, the control unit 110 performs the control of the driving frequency of the alternating-current signals (step S311) or the control of the pulse width of the alternating-current signals (step S312) that is performed at the time prior to the specific time.

In such a manner, the driving frequency and pulse width of the alternating-current signals are controlled depending on the sign of the value of the speed deviation, whereby a sharp decrease in speed and speed fluctuations during the deceleration of the vibration actuator 200 can be prevented. This can prevent unstable driving of the driving target by the vibration actuator 200 and reduce driving noise of the vibration actuator 200.

In the present exemplary embodiment, the driving control of the vibration actuator 200 is performed using the pulse width and driving frequency of the alternating-current signals. However, similar effects can be obtained by using voltage control for changing the voltage to be switched instead of the pulse width control of the alternating-current signals.

### Modifications of First and Second Exemplary Embodiments

Modifications of the foregoing first and second exemplary embodiments will now be described.

In the foregoing first and second exemplary embodiments, whether the value of the speed deviation (first value) is positive is described to be determined in step S201 of FIG. 6 or step S301 of FIG. 8. However, the present disclosure is not limited thereto. For example, determinations may be made by combining the value of the speed deviation (first value) with the value of a position deviation (second value) obtained by subtracting the actual position that is the current value from the command position that is the command value and the value of an acceleration deviation (third value) obtained by subtracting actual acceleration that is the current value from a threshold, respectively. Here, the threshold is a value determined by actual measurement, for example, and determined from the value of the noise level of the vibration actuator 200. Moreover, if at least one or more of the values of the speed deviation, position deviation, and acceleration deviation are determined to be other than positive, the pulse width or driving frequency of the alternating-current signals may be controlled to that of the alternating-current signals in the previous control cycle like the first and second exemplary embodiments.

In the modifications of the first and second exemplary embodiments, the value of the position deviation (second value) and the value of the acceleration deviation (third value), like the value of the speed deviation (first value) in the foregoing first and second exemplary embodiments, are not limited to positive ones. For example, certain ranges of values determined by actual measurement in advance may be used.

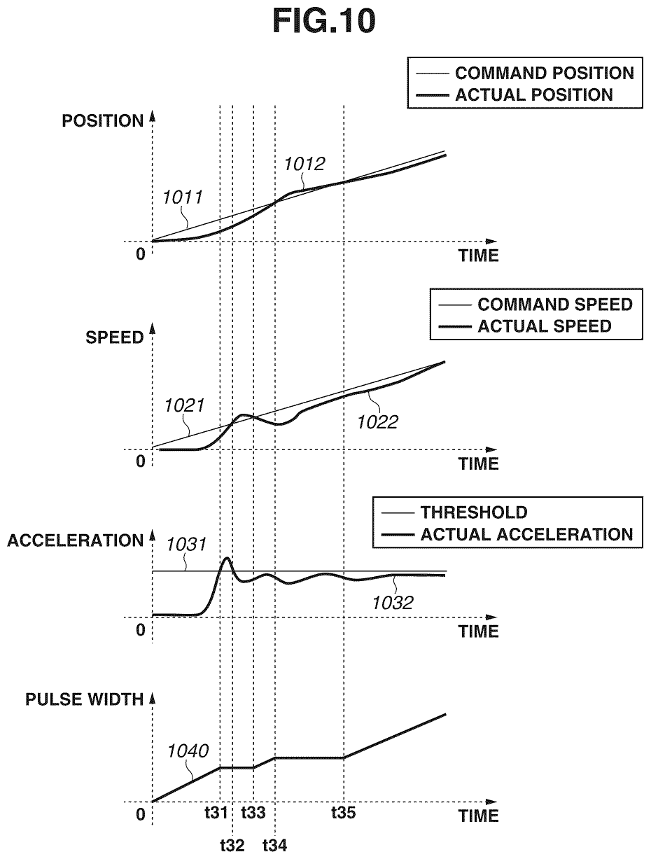

FIG. 10 is a diagram illustrating the modifications of the first and second exemplary embodiments of the present disclosure, illustrating a relationship between the position, speed, and acceleration of the vibration actuator 200 and the pulse width of the alternating-current signals. Specifically, FIG. 10 illustrates a command position 1011 and an actual position 1012 concerning the position of the vibration actuator 200, and a command speed 1021 and an actual speed 1022 concerning the speed of the vibration actuator 200. FIG. 10 also illustrates a threshold 1031 and an actual acceleration 1032 concerning the acceleration of the vibration actuator 200 and a pulse width 1040 of the alternating-current signals. FIG. 10 illustrates a case during the acceleration control of the vibration actuator 200 as an example.

When the acceleration control of the vibration actuator 200 is started, the control unit 110 increases the pulse width 1040 of the alternating-current signals until time t31 of FIG. 10.

In FIG. 10, in the period from time t31 to time t32 of the control cycle subsequent to time t31, the actual acceleration 1032 exceeds the threshold 1031. In other words, in the period from time t31 to time t32, the value of the acceleration deviation (third value) obtained by subtracting the actual acceleration 1032 that is the current value from the threshold 1031 is other than positive. In this period, the control unit 110 maintains the pulse width 1040 of the alternating-current signals at the same value as the pulse width of the alternating-current signals at time t31.

In FIG. 10, in the period from time t32 to time t33 of the control cycle subsequent to time t32, the value of the speed deviation (first value) obtained by subtracting the actual speed 1022 from the command speed 1021 is other than positive. In this period, the control unit 110 maintains the pulse width 1040 of the alternating-current signals at the same value as the pulse width of the alternating-current signals at time t32.

In FIG. 10, in the period from time t33 to time t34 of the control cycle subsequent to time t33, the value of the speed deviation (first value), the value of the position deviation (second value), and the value of the acceleration deviation (third value) are all positive values. In this period, the control unit 110 performs control to increase the pulse width 1040 of the alternating-current signals.

In FIG. 10, in the period from time t34 to time t35 of the control cycle subsequent to time t34, the value of the position deviation (second value) obtained by subtracting the actual position 1012 from the command position 1011 is other than positive. In this period, the control unit 110 maintains the pulse width 1040 of the alternating-current signals at the same value as the pulse width of the alternating-current signals at time t34.

In FIG. 10, at and after time t35, the value of the speed deviation (first value), the value of the position deviation (second value), and the value of the acceleration deviation (third value) are all positive values. In this period, the control unit 110 performs the control to increase the pulse width 1040 of the alternating-current signals.

As described above, if at least one of the value of the speed deviation (first value), the value of the position deviation (second value), and the value of the acceleration deviation (third value) is other than positive, the pulse width control and the driving frequency control of the alternating-current signals in the previous control cycle may be performed. This can further prevent unstable driving of the driving target by the vibration actuator 200, and can further reduce the driving noise of the vibration actuator 200.

The foregoing modifications of the first exemplary embodiment and the foregoing modification of the second exemplary embodiment will each be described in the concrete below.

### Modification of First Exemplary Embodiment

In the modification of the first exemplary embodiment, the control unit 110 performs the following control depending on the value of the position deviation (second value) that is a value concerning the relative position of the vibrating body 210 and the contact spring 222 and obtained by subtracting the current value from the command value at a specific time during acceleration of the vibration actuator 200. If the value of the position deviation (second value) is positive, the control unit 110 performs the control to decrease the driving frequency of the alternating-current signals (step S208) or the control to increase the pulse width of the alternating-current signals (step S204). Here, the control to increase the pulse width of the alternating-current signals (step S204) is equivalent to the control to increase the effective voltage of the alternating-current signals. If the foregoing value of the position deviation (second value) is other than positive, the control unit 110 performs the control of the driving frequency of the alternating-current signals (step S212) or the control of the pulse width of the alternating-current signals (step S211) that is performed at the time prior to the specific time.

In the modification of the first exemplary embodiment, the control unit 110 performs the following control depending on the value of the acceleration deviation (third value) that is a value concerning the relative acceleration between the vibrating body 210 and the contact spring 222 and obtained by subtracting the current value from the threshold at a specific time during acceleration of the vibration actuator 200. If the value of the acceleration deviation (third value) is positive, the control unit 110 performs the control to decrease the driving frequency of the alternating-current signals (step S208) or the control to increase the pulse width of the alternating-current signals (step S204). Here, the control to increase the pulse width of the alternating-current signals (step S204) is equivalent to the control to increase the effective voltage of the alternating-current signals. If the foregoing value of the acceleration deviation (third value) is other than positive, the control unit 110 performs the control of the driving frequency of the alternating-current signals (step S212) or the control of the pulse width of the alternating-current signals (step S211) that is performed at the time prior to the specific time.

### Modification of Second Exemplary Embodiment

In the modification of the second exemplary embodiment, the control unit 110 performs the following control depending on the value of the position deviation (second value) that is a value concerning the relative position between the vibrating body 210 and the contact spring 222 and obtained by subtracting the current value from the command value at a specific time during deceleration of the vibration actuator 200. If the value of the position deviation (second value) is positive, the control unit 110 performs the control to increase the driving frequency of the alternating-current signals (step S304) or the control to decrease the pulse width of the alternating-current signals (step S308). Here, the control to decrease the pulse width of the alternating-current signals (step S308) is equivalent to the control to decrease the effective voltage of the alternating-current signals. If the foregoing value of the position deviation (second value) is other than positive, the control unit 110 performs the control of the driving frequency of the alternating-current signals (step S311) or the control of the pulse width of the alternating-current signals (step S312) that is performed at the time prior to the specific time.

In the modification of the second exemplary embodiment, the control unit 110 performs the following control depending on the value of the acceleration deviation (third value) that is a value concerning the relative acceleration between the vibrating body 210 and the contact spring 222 and obtained by subtracting the current value from the threshold at a specific time during deceleration of the vibration actuator 200. If the value of the acceleration deviation (third value) is positive, the control unit 110 performs the control to increase the driving frequency of the alternating-current signals (step S304) or the control to decrease the pulse width of the alternating-current signals (step S308). Here, the control to decrease the pulse width of the alternating-current signals (step S308) is equivalent to the control to decrease the effective voltage of the alternating-current signals. If the foregoing value of the acceleration deviation (third value) is other than positive, the control unit 110 performs the control of the driving frequency of the alternating-current signals (step S311) or the control of the pulse width of the alternating-current signals (step S312) that is performed at the time prior to the specific time.

### Third Exemplary Embodiment

Next, a third exemplary embodiment will be described. In the following description of the third exemplary embodiment, a description of items common to the foregoing first and second exemplary embodiments will be omitted, and differences from the foregoing first and second exemplary embodiments will be mainly described.

A hardware configuration of a vibration driving apparatus according to the third exemplary embodiment is similar to that of the vibration driving apparatus 10 according to the first exemplary embodiment illustrated in FIG. 3. A functional configuration of the vibration driving apparatus 10 according to the third exemplary embodiment is similar to that of the vibration driving apparatus 10 according to the first exemplary embodiment illustrated in FIG. 4. A processing procedure of a method for controlling the vibration actuator 200 by the control apparatus 100 according to the third exemplary embodiment is similar to that of the method for controlling the vibration actuator 200 by the control apparatus 100 according to the first exemplary embodiment illustrated in FIG. 5. A detailed processing procedure during the acceleration control in step S104 of FIG. 5 according to the third exemplary embodiment is similar to that during the acceleration control in step S104 of FIG. 5 according to the first exemplary embodiment illustrated in FIG. 6.

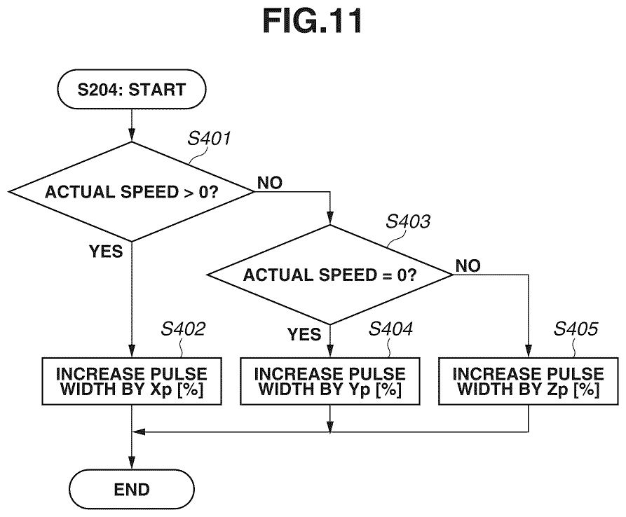

FIG. 11 is a flowchart illustrating the third exemplary embodiment of the present disclosure, illustrating an example of a detailed processing procedure of the control to increase the pulse width of the alternating-current signals in step S204 of FIG. 6. Specifically, FIG. 11 illustrates the process of one control cycle from start to end.

When the processing of step S204 in FIG. 6 is started, in step S401 of FIG. 11, the control unit 110 initially determines whether the actual speed calculated by the current value calculation unit 114 is higher than 0.

If, as a result of the determination in step S401, the actual speed calculated by the current value calculation unit 114 is higher than 0 (YES in step S401), the processing proceeds to step S402.

In step S402, the control unit 110 increases the pulse width of the alternating-current signals by Xp % as αp in step S204 of FIG. 6. As an example of increasing the pulse width of the alternating-current signals by Xp %, the control unit 110 increases the pulse width of the alternating-current signals at 1%/ms.

On the other hand, if, as a result of the determination in step S401, the actual speed calculated by the current value calculation unit 114 is not higher than 0 (is lower than or equal to 0) (NO in step S401), the processing proceeds to step S403.

In step S403, the control unit 110 determines whether the actual speed calculated by the current value calculation unit 114 is 0.

If, as a result of the determination in step S403, the actual speed calculated by the current value calculation unit 114 is 0 (YES in step S403), the processing proceeds to step S404.

In step S404, the control unit 110 increases the pulse width of the alternating-current signals by Yp % as αp in step S204 of FIG. 6. As an example of increasing the pulse width of the alternating-current signals by Yp %, the control unit 110 increases the pulse width of the alternating-current signals at 3%/ms.

If, as a result of the determination in step S403, the actual speed calculated by the current value calculation unit 114 is not 0 (is lower than 0) (NO in step S403), the processing proceeds to step S405.

In step S405, the control unit 110 increases the pulse width of the alternating-current signals by Zp % as αp in step S204 of FIG. 6. As an example of increasing the pulse width of the alternating-current signals by Zp %, the control unit 110 increases the pulse width of the alternating-current signals at 5%/ms.

If the processing of step S402 ends, if the processing of step S404 ends, or if the processing of step S405 ends, the processing of the flowchart illustrated in FIG. 11 ends.

In the present exemplary embodiment, as described above, the amount of increase Xp in the pulse width in step S402, the amount of increase Yp in the pulse width in step S404, and the amount of increase Zp in the pulse width in step S405 have magnitudes such that Xp<Yp<Zp.

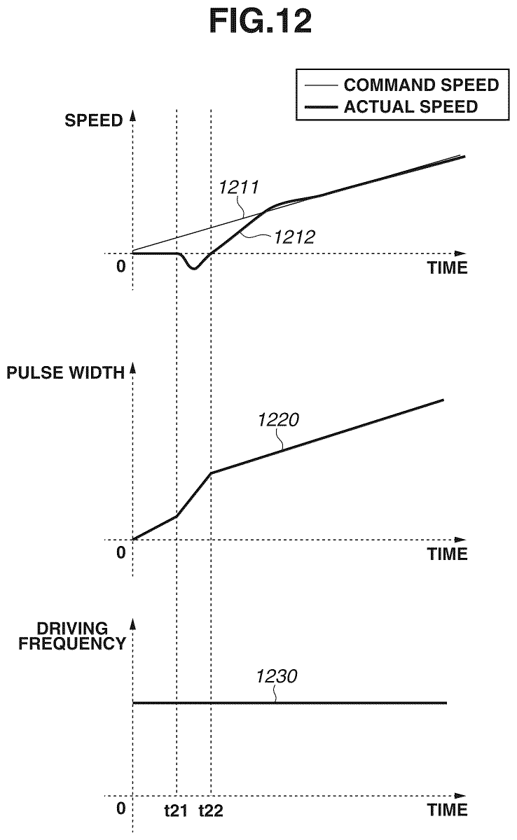

FIG. 12 is a diagram illustrating the third exemplary embodiment of the present disclosure, illustrating a relationship between the speed of the vibration actuator 200 and the pulse width and driving frequency of the alternating-current signals during the acceleration control in step S104 of FIG. 5. Specifically, FIG. 12 illustrates a command sped 1211 and an actual speed 1212 concerning the speed of the vibration actuator 200, a pulse width 1220 of the alternating-current signals, and a driving frequency 1230 of the alternating-current signals.

In FIG. 12, in the period from a start (time 0) to time t21, the actual speed 1212 is 0. In this period, the control unit 110 performs control to increase the pulse width 1220 of the alternating-current signals by Yp % (step S404). Specifically, in the present exemplary embodiment, the control unit 110 performs control to increase the pulse width 1220 of the alternating-current signals at 3%/ms.

In FIG. 12, in the period from time t21 to time t22, the actual speed 1212 is lower than 0. In this period, the control unit 110 performs control to increase the pulse width 1220 of the alternating-current signals by Zp % (step S405). Specifically, in the present exemplary embodiment, the control unit 110 performs control to increase the pulse width 1220 of the alternating-current signals at 5%/ms.

In FIG. 12, in the period from time t22 onward, the actual speed 1212 is higher than 0. In this period, the control unit 110 performs control to increase the pulse width 1220 of the alternating-current signals by Xp % (S402). Specifically, in the present exemplary embodiment, the control unit 110 performs control to increase the pulse width 1220 at 1%/ms.

In the present exemplary embodiment, when the actual speed 1212 is 0, the control unit 110 sets the amount of change (Yp) over time during the control to increase the pulse width 1220 of the alternating-current signals to be greater than the amount of change (Xp) when the actual speed 1212 is positive. In the present exemplary embodiment, when the actual speed 1212 is negative, the control unit 110 sets the amount of change (Zp) over time during the control to increase the pulse width 1220 of the alternating-current signals to be greater than the amount of change (Yp) when the actual speed 1212 is 0.

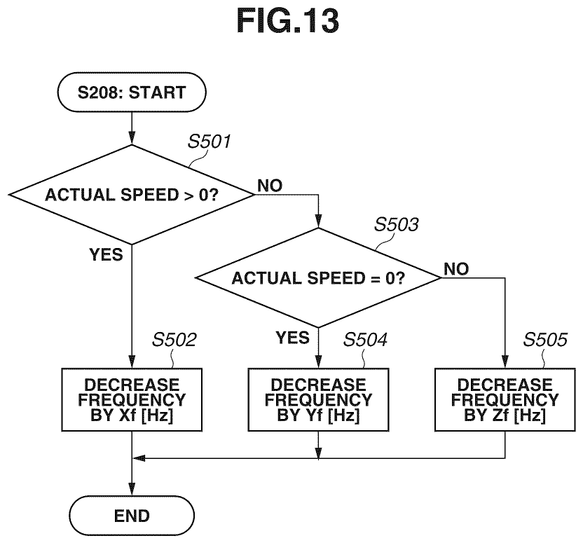

FIG. 13 is a flowchart illustrating the third exemplary embodiment of the present disclosure, illustrating an example of a detailed processing procedure of the control to decrease the driving frequency of the alternating-current signals in step S208 of FIG. 6. Specifically, FIG. 13 illustrates the process of one control period from start to end.

When the processing of step S208 in FIG. 6 is started, then in step S501 of FIG. 13, the control unit 110 determines whether the actual speed calculated by the current value calculation unit 114 is higher than 0.

If, as a result of the determination in step S501, the actual speed calculated by the current value calculation unit 114 is higher than 0 (YES in step S501), the processing proceeds to step S502.

In step S502, the control unit 110 decreases the driving frequency of the alternating-current signals by Xf % as αf in step S208 of FIG. 6. As an example of decreasing the driving frequency of the alternating-current signals by Xf %, the control unit 110 decreases the driving frequency of the alternating-current signals at 10 Hz/ms. On the other hand, if, as a result of the determination in step S501, the actual speed calculated by the current value calculation unit 114 is not higher than 0 (is lower than or equal to 0) (NO in step S501), the processing proceeds to step S503.

In step S503, the control unit 110 determines whether the actual speed calculated by the current value calculation unit 114 is 0.

If, as a result of the determination in step S503, the actual speed calculated by the current value calculation unit 114 is 0 (YES in step S503), the processing proceeds to step S504.

In step S504, the control unit 110 decreases the driving frequency of the alternating-current signals by Yf % as αf in step S208 of FIG. 6. As an example of decreasing the driving frequency of the alternating-current signals by Yf %, the control unit 110 decreases the driving frequency of the alternating-current signals at 30 Hz/ms.

On the other hand, if, as a result of the determination in step S503, the actual speed calculated by the current value calculation unit 114 is not 0 (is lower than 0) (NO in step S503), the processing proceeds to step S505.

In step S505, the control unit 110 decreases the driving frequency of the alternating-current signals by Zf % as αf in step S208 of FIG. 6. As an example of decreasing the driving frequency of the alternating-current signals by Zf %, the control unit 110 decreases the driving frequency of the alternating-current signals at 50 Hz/ms.

If the processing of step S502 ends, if the processing of step S504 ends, or if the processing of step S505 ends, the processing of the flowchart illustrated in FIG. 13 ends.

In the present exemplary embodiment, as described above, the amount of decrease Xf in the driving frequency in step S502, the amount of decrease Yf in the driving frequency in step S504, and the amount of decrease Zf in the driving frequency in step S505 have magnitudes such that Xf<Yf<Zf.

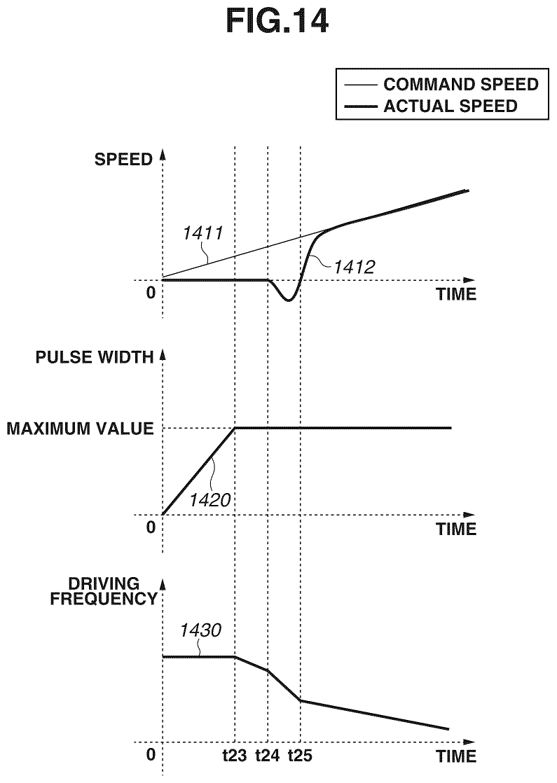

FIG. 14 is a diagram illustrating the third exemplary embodiment of the present disclosure, illustrating a relationship between the speed of the vibration actuator 200 and the pulse width and driving frequency of the alternating-current signals during the acceleration control in step S104 of FIG. 5. Specifically, FIG. 14 illustrates a command speed 1411 and an actual speed 1412 concerning the speed of the vibration actuator 200, a pulse width 1420 of the alternating-current signals, and a driving frequency 1430 of the alternating-current signals.

In FIG. 14, in the period from time t23 when the pulse width 1420 of the alternating-current signals reaches a maximum value (for example, 50%) to time t24, the actual speed 1412 is 0. In this period, the control unit 110 performs control to decrease the driving frequency 1430 of the alternating-current signals by Yf % (step S504). Specifically, in the present exemplary embodiment, the control unit 110 performs control to decrease the driving frequency 1430 of the alternating-current signals at 30 Hz/ms.

In FIG. 14, in the period from time t24 to t25, the actual speed 1412 is lower than 0. In this period, the control unit 110 performs control to decrease the driving frequency 1430 of the alternating-current signals by Zf % (step S505). Specifically, in the present exemplary embodiment, the control unit 110 performs control to decrease the driving frequency 1430 of the alternating-current signals at 50 Hz/ms.

In FIG. 14, in the period from time t25 onward, the actual speed 1412 is higher than 0. In this period, the control unit 110 performs control to decrease the driving frequency 1430 of the alternating-current signals by Xf % (step S502). Specifically, in the present exemplary embodiment, the control unit 110 performs control to decrease the driving frequency 1430 of the alternating-current signals at 10 Hz/ms.

In the present exemplary embodiment, when the actual speed 1412 is 0, the control unit 110 sets the amount of change (Yf) over time during the control to decrease the driving frequency 1430 of the alternating-current signals to be greater than the amount of change (Xf) when the actual speed 1412 is positive. In the present exemplary embodiment, when the actual speed 1412 is negative, the control unit 110 sets the amount of change (Zf) over time during the control to decrease the driving frequency 1430 of the alternating-current signals to be greater than the amount of change (Yf) when the actual speed 1412 is 0.

According to the third exemplary embodiment, the startup delay of the vibration actuator 200 can be reduced, a sharp increase in speed can be prevented, and the driving noise of the vibration actuator 200 can be reduced.

### Fourth Exemplary Embodiment

Next, a fourth exemplary embodiment will be described. In the following description of the fourth exemplary embodiment, a description of items common to the foregoing first to third exemplary embodiments will be omitted, and differences from the foregoing first to third exemplary embodiments will be mainly described.

A hardware configuration of a vibration driving apparatus according to the fourth exemplary embodiment is similar to that of the vibration driving apparatus 10 according to the first exemplary embodiment illustrated in FIG. 3. A functional configuration of the vibration driving apparatus 10 according to the fourth exemplary embodiment is similar to that of the vibration driving apparatus 10 according the first exemplary embodiment illustrated in FIG. 4. A processing procedure of a method for controlling the vibration actuator 200 by the control apparatus 100 according to the fourth exemplary embodiment is similar to that of the method for controlling the vibration actuator 200 by the control apparatus 100 according to the first exemplary embodiment illustrated in FIG. 5.

The foregoing first to third exemplary embodiments have dealt with the pulse width control where the speed of the vibration actuator 200 is changed using the pulse width of the alternating-current signals in the low-speed range in starting and stopping the vibration actuator 200. The present disclosure is not limited to such modes. For example, the speed of the vibration actuator 200 in the low-speed range may be changed by changing a phase difference between the two-phase alternating-current signals that generate vibrations in A- and B-modes. The control performed depending on a deviation in the position or speed of the vibration actuator 200 using the phase difference between the two-phase alternating-current signals that generate vibrations in A- and B-modes will be referred to as an AB phase difference control.

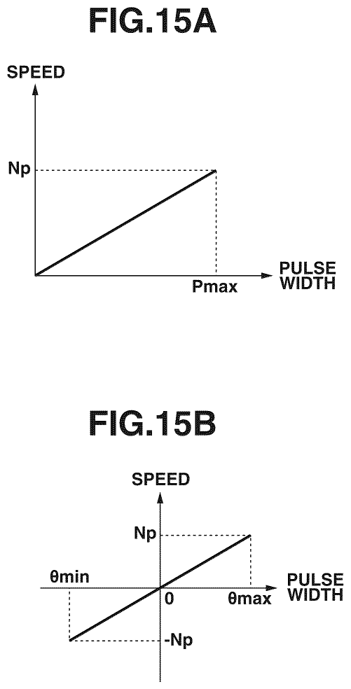

FIGS. 15A and 15B are diagrams illustrating the fourth exemplary embodiment of the present disclosure, illustrating a relationship between the pulse width of the alternating-current signals and the speed of the vibration actuator 200 and a relationship between the phase difference between the two-phase alternating-current signals and the speed of the vibration actuator 200. Specifically, FIG. 15A is a diagram illustrating the relationship between the pulse width of the alternating-current signals and the speed of the vibration actuator 200. FIG. 15B is a diagram illustrating the relationship between the phase difference (AB phase difference) between the two-phase alternating-current signals and the speed of the vibration actuator 200.

In FIG. 15A, the maximum value of the pulse width of the alternating-current signals is denoted by Pmax. In FIGS. 15A and 15B, an optimum speed for transition from pulse width control to frequency control at is denoted by Np. In FIG. 15B, the maximum value of the phase difference is denoted by θmax, and the minimum value of the phase difference is denoted by θmin.

As illustrated in FIG. 15A, in the case of the pulse width control, the speed increases up to Np as the pulse width increases to the maximum value Pmax of the pulse width. Here, the phase difference illustrated in FIG. 15B determines the driving direction of the vibration actuator 200, with the maximum value θmax of the phase difference in the forward direction and the minimum value θmin of the phase difference in the reverse direction. The relationship between the AB phase difference and the driving direction varies depending on the configuration of the vibration actuator 200, and the relationship illustrated in FIG. 15B holds in the present exemplary embodiment. More specifically, as illustrated in FIG. 15B, the relationship is such that the forward speed increases as the phase difference increases in the positive direction, and the reverse speed increases as the phase difference increases in the negative direction. In such a case, the pulse width of the alternating-current signals is set to the maximum value Pmax of the pulse width, for example. The relationship between the phase difference and the speed as illustrated in FIG. 15B enables control similar to the pulse width control even with the phase difference control.

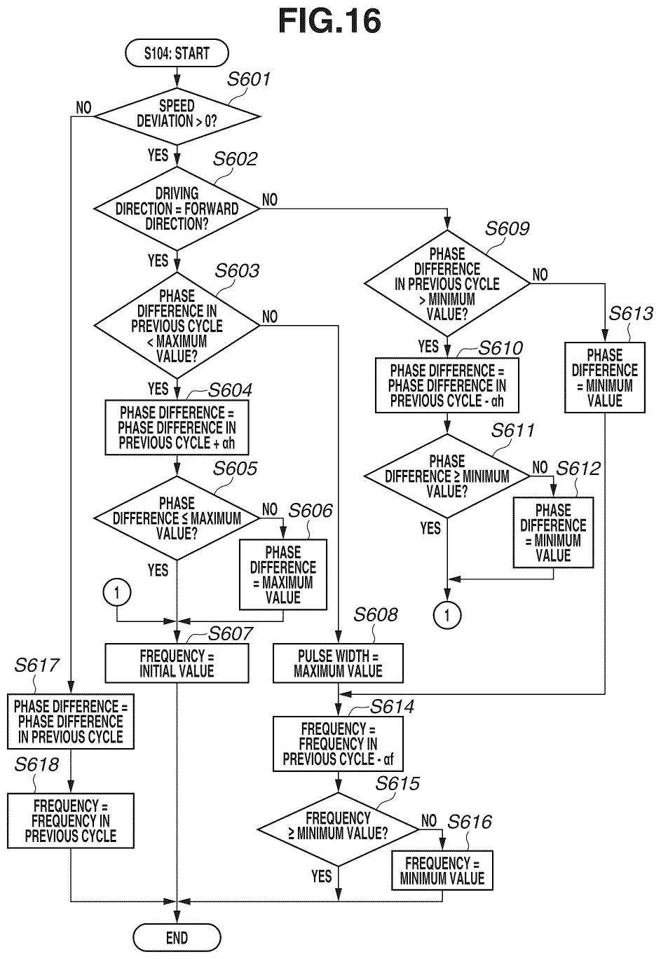

Next, as an example of the phase difference control according to the fourth exemplary embodiment, a processing procedure of acceleration control of the vibration actuator 200 will be described. FIG. 16 is a flowchart illustrating the fourth exemplary embodiment of the present disclosure, illustrating an example of a detailed processing procedure of the acceleration control in step S104 of FIG. 5. Specifically, FIG. 16 illustrates the process of one control cycle of the acceleration control in step S104 of FIG. 5 from start to end. More specifically, FIG. 16 is the flowchart illustrated in FIG. 6 to which the phase difference is applied instead of the pulse width of the alternating-current signals.

The relationship between the speed of the vibration actuator 200 and the phase difference and driving frequency of the alternating-current signals is substantially the same as in the first exemplary embodiment where the pulse width of the alternating-current signals is replaced with the phase difference. A description thereof will thus be omitted.

When the acceleration control in step S104 of FIG. 5 is started, then in step S601 of FIG. 16, the control unit 110 initially determines whether the value of the speed deviation obtained by subtracting the actual speed calculated by the current value calculation unit 114 from the command speed generated by the command value generation unit 111 is positive. The processing of this step S601 is performed by the deviation determination unit 115 of the control unit 110, for example. In the present exemplary embodiment, the value of the speed deviation in step S601 corresponds to the “first value” that is a value concerning the relative speed between the vibrating body 210 and the contact spring 222 and obtained by subtracting the current value from the command value generated to approach the target value at a specific time during acceleration of the vibration actuator 200.

If, as a result of the determination in step S601, the value of the speed deviation is positive (YES in step S601), the processing proceeds to step S602.

In step S602, the control unit 110 determines whether the driving direction of the vibration actuator 200 is the forward direction.

If, as a result of the determination in step S602, the driving direction of the vibration actuator 200 is the forward direction (YES in step S602), the processing proceeds to step S603.

In step S603, the control unit 110 determines whether the phase difference between the alternating-current signals in the previous control cycle is less than the maximum value.

If, as a result of the determination in step S603, the phase difference between the alternating-current signals in the previous control cycle is less than the maximum value (YES in step S603), the processing proceeds to step S604.

In step S604, the control unit 110 sets the value obtained by adding h to the phase difference between the alternating-current signals in the previous control cycle as the phase difference of the alternating-current signals. αh here is the amount of increase in the phase difference between the alternating-current signals in one control cycle.

Next, in step S605, the control unit 110 determines whether the phase difference between the alternating-current signals is less than or equal to the maximum value.

If, as a result of the determination in step S605, the phase difference between the alternating-current signals is not less than or equal to the maximum value (the phase difference is greater than the maximum value) (NO in step S605), the processing proceeds to step S606.

In step S606, the control unit 110 sets the phase difference between the alternating-current signals to the maximum value.

If the phase difference between the alternating-current signals is determined to be less than or equal to the maximum value in step S605 (YES in step S605) or if the processing of step S606 ends, the processing proceeds to step S607.

In step S607, the control unit 110 sets the driving frequency of the alternating-current signals to an initial value. When the processing of step S607 ends, the processing of the flowchart illustrated in FIG. 16 at the time of the current control cycle of the acceleration control ends.

If, as a result of the determination in step S603, the phase difference between the alternating-current signals in the previous control cycle is not less than to the maximum value (the phase difference is greater than or equal to the maximum value) (NO in step S603), the processing proceeds to step S608.

In step S608, the control unit 110 sets the phase difference between the alternating-current signals to the maximum value.

If, as a result of the determination in step S602, the driving direction of the vibration actuator 200 is not the forward direction (NO in step S602), the processing proceeds to step S609.

In step S609, the control unit 110 determines whether the phase difference between the alternating-current signals in the previous control cycle is greater than the minimum value.

If, as a result of the determination in step S609, the phase difference between the alternating-current signals in the previous control cycle is greater than the minimum value (YES in step S609), the processing proceeds to step S610.

In step S610, the control unit 110 sets the value obtained by subtracting ah from the phase difference between the alternating-current signals in the previous control cycle as the phase difference between the alternating-current signals. αh here is the amount of decrease in the phase difference between the alternating-current signals in one control cycle.

Next, in step S611, the control unit 110 determines whether the phase difference between the alternating-current signals is greater than or equal to the minimum value.

If, as a result of the determination in step S611, the phase difference between the alternating-current signals is not greater than or equal to the minimum value (the phase difference is less than the minimum value) (NO in step S611), the processing proceeds to step S612.

In step S612, the control unit 110 sets the phase difference between the alternating-current signals to the minimum value.

If the phase difference between the alternating-current signals is determined to be greater than or equal to the minimum value in step S611 (YES in step S611) or if the processing of step S612 ends, the processing proceeds to step S607. In step S607, the control unit 110 sets the driving frequency of the alternating-current signals to the initial value. The processing of the flowchart illustrated in FIG. 16 ends.

If, as a result of the determination in step S609, the phase difference between the alternating-current signals in the previous control cycle is not greater than the minimum value (the phase difference is less than or equal to the minimum value) (NO in step S609), the processing proceeds to step S613.

In step S613, the control unit 110 sets the phase difference between the alternating-current signals to the minimum value.

If the processing of step S608 ends or if the processing of step S613 ends, the processing proceeds to step S614.

In step S614, the control unit 110 sets the value obtained by subtracting αf from the driving frequency of the alternating-current signals in the previous control cycle as the driving frequency of the alternating-current signals. This αf is the amount of decrease in the driving frequency of the alternating-current signals in one control cycle.

Next, in step S615, the control unit 110 determines whether the driving frequency of the alternating-current signals is higher than or equal to the minimum value.

If, as a result of the determination in step S615, the driving frequency of the alternating-current signals is not higher than or equal to the minimum value (the driving frequency is lower than the minimum value) (NO in step S615), the processing proceeds to step S616.

In step S616, the control unit 110 sets the driving frequency of the alternating-current signals to the minimum value.

If the driving frequency of the alternating-current signals is determined to be higher than or equal to the minimum value in step S615 (YES in step S615) or if the processing of step S616 ends, the processing of the flowchart illustrated in FIG. 16 at the time of the current control cycle of the acceleration control ends.

If, as a result of the determination in step S601, the value of the speed deviation is not positive (the value of the speed deviation is other than positive) (NO in step S601), the processing proceeds to step S617.

In step S617, the control unit 110 sets the phase difference between the alternating-current signals to that between the alternating-current signals at the time of the previous control cycle immediately preceding this control cycle.

Next, in step S618, the control unit 110 sets the driving frequency of the alternating-current signals to that of the alternating-current signals at the time of the previous control cycle immediately preceding this control cycle.

When the processing of step S618 ends, the processing of the flowchart illustrated in FIG. 16 at the time of the current control cycle of the acceleration control ends.

The fourth exemplary embodiment also employs the mode of applying “the phase difference control of the alternating-current signals” instead of the “pulse width control of the alternating-current signals” in the foregoing first exemplary embodiment even for other items, for example.

In the control apparatus 100 according to the fourth exemplary embodiment described above, the control unit 110 performs the following processing at a specific time during acceleration of the vibration actuator. If the value of the speed deviation (first value) obtained by subtracting the current value from the command value concerning the relative speed between the vibrating body 210 and the contact spring 222 is positive, the control unit 110 performs the control to decrease the driving frequency of the alternating-current signals (step S614) or the control to increase the phase difference between the alternating-current signals (step S604). If the foregoing value of the speed deviation (first value) is other than positive, the control unit 110 performs the control of the driving frequency of the alternating-current signals (step S618) or the control of the phase difference between the alternating-current signals (step S617) that is performed at the time prior to the specific time.

In such a manner, the driving frequency of or the phase difference between the alternating-current signals is controlled depending on the sign of the value of the speed deviation, whereby a sharp increase in speed and speed fluctuations during the acceleration of the vibration actuator 200 can be prevented. This can prevent unstable driving of the driving target by the vibration actuator 200 and reduce driving noise of the vibration actuator 200.

[Modifications of Fourth Exemplary Embodiment]

The fourth exemplary embodiment has dealt with the acceleration control of the vibration actuator 200. However, the fourth exemplary embodiment is also applicable to the deceleration control of the vibration actuator 200. Here, as a modification of the fourth exemplary embodiment, a mode of applying the “phase difference control of the alternating-current signals” according to the fourth exemplary embodiment is employed instead of the “pulse width control of the alternating-current signals” according to the foregoing second exemplary embodiment.

Specifically, in the modification of the fourth exemplary embodiment, the following processing is performed at a specific time during deceleration of the vibration actuator 200. If the value of the speed deviation (first value) is positive, the control unit 110 employs a mode of performing the control to increase the driving frequency of the alternating-current signals or the control to decrease the phase difference between the alternating-current signals. If the foregoing value of the speed deviation (first value) is other than positive, the control unit 110 employs a mode of performing the control of the driving frequency of the alternating-current signals or the control of the phase difference between the alternating-current signals that is performed at the time prior to the specific time.

Moreover, as a modification of the fourth exemplary embodiment, a mode of applying the “phase difference control of the alternating-current signals” according to the fourth exemplary embodiment is employed instead of the “pulse width control of the alternating-current signals” in the foregoing [modification of the first exemplary embodiment].

In the modification of the fourth exemplary embodiment, the control unit 110 performs the following control depending on the value of the position deviation (second value) that is a value concerning the relative position between the vibrating body 210 and the contact spring 222 and obtained by subtracting the current value from the command value at a specific time during acceleration of the vibration actuator 200. If the value of the position deviation (second value) is positive, the control unit 110 performs the control to decrease the driving frequency of the alternating-current signals or the control to increase the phase difference between the alternating-current signals. If the foregoing value of the position deviation (second value) is other than positive, the control unit 110 performs the control of the driving frequency of the alternating-current signals or the control of the phase difference between the alternating-current signals that is performed at the time prior to the specific time.

In the modification of the fourth exemplary embodiment, the control unit 110 performs the following control depending on the value of the acceleration deviation (third value) that is a value concerning the relative acceleration between the vibrating body 210 and the contact spring 222 and obtained by subtracting the current value from the threshold at a specific time during acceleration of the vibration actuator 200. If the value of the acceleration deviation (third value) is positive, the control unit 110 performs the control to decrease the driving frequency of the alternating-current signals or the control to increase the phase difference between the alternating-current signals. If the foregoing value of the acceleration deviation (third value) is other than positive, the control unit 110 performs the control of the driving frequency of the alternating-current signals or the control of the phase difference between the alternating-current signals that is performed at the time prior to the specific time.

Furthermore, as a modification of the fourth exemplary embodiment, a mode of applying the “phase difference control of the alternating-current signals” according to the fourth exemplary embodiment is employed instead of the “pulse width control of the alternating-current signals” according to the foregoing [modification of the second exemplary embodiment].

In the modification of the fourth exemplary embodiment, the control unit 110 performs the following control depending on the value of the position deviation (second value) that is a value concerning the relative position between the vibrating body 210 and the contact spring 222 and obtained by subtracting the current value from the command value at a specific time during deceleration of the vibration actuator 200. If the value of the position deviation (second value) is positive, the control unit 110 performs the control to increase the driving frequency of the alternating-current signals or the control to decrease the phase difference between the alternating-current signals. If the foregoing value of the position deviation (second value) is other than positive, the control unit 110 performs the control of the driving frequency of the alternating-current signals or the control of the phase difference between the alternating-current signals that is performed at the time prior to the specific time.

In the modification of the fourth exemplary embodiment, the control unit 110 performs the following control depending on the value of the acceleration deviation (third value) that is a value concerning the relative acceleration between the vibrating body 210 and the contact spring 222 and obtained by subtracting the current value from the threshold at a specific time during deceleration of the vibration actuator 200. If the value of the acceleration deviation (third value) is positive, the control unit 110 performs the control to increase the driving frequency of the alternating-current signals or the control to decrease the phase difference between the alternating-current signals. If the foregoing value of the acceleration deviation (third value) is other than positive, the control unit 110 performs the control of the driving frequency of the alternating-current signals or the control of the phase difference between the alternating-current signals that is performed at the time prior to the specific time.

### Fifth Exemplary Embodiment

Next, a fifth exemplary embodiment will be described. In the following description of the fifth exemplary embodiment, a description of items common to the foregoing first to fourth exemplary embodiments will be omitted, and differences from the foregoing first to fourth exemplary embodiments will be mainly described.

The fifth exemplary embodiment deals with a mode where an imaging apparatus (optical device) such as a camera is applied as an example of an electronic device including the vibration driving apparatus 10 according to the foregoing first, second, third, or fourth exemplary embodiment.

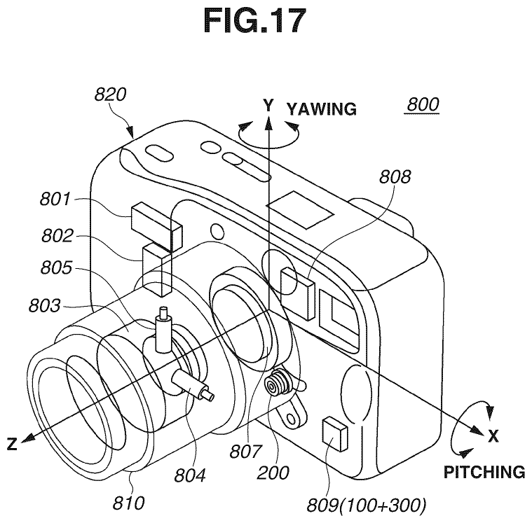

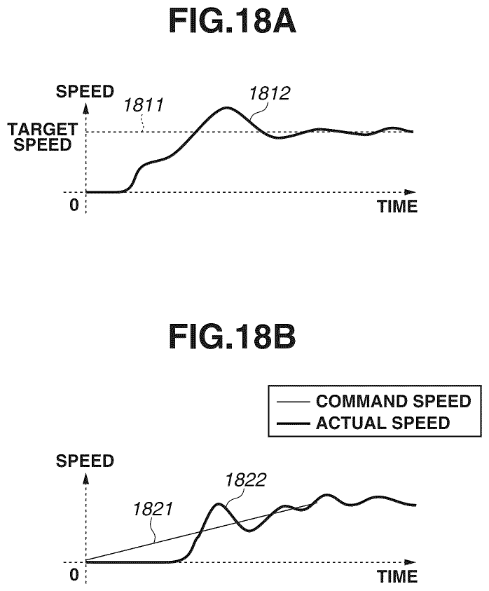

FIG. 17 is a diagram illustrating the fifth exemplary embodiment of the present disclosure, illustrating a configuration example where an imaging apparatus 800 is applied as the electronic device including the vibration driving apparatus 10 according to the first, second, third, or fourth exemplary embodiment.

A lens barrel 810 is mounted on the front of the imaging apparatus 800 (more specifically, an imaging apparatus main body 820). A plurality of lenses (not illustrated) including a focus lens 807 and a camera shake correction optical system 803 are disposed inside the lens barrel 810. Rotations of two-axis coreless motors 804 and 805 are transmitted to the camera shake correction optical system 803, whereby the camera shake correction optical system 803 can be vibrated in a vertical direction (Y direction) and a horizontal direction (X direction).

The imaging apparatus main body 820 includes an image sensor 808. Light passed through the lens barrel 810 forms an optical image on this image sensor 808. The image sensor 808 is a photoelectric conversion device such as a complementary metal-oxide-semiconductor (CMOS) sensor or a charge-coupled device (CCD) sensor, and converts the optical image into an analog electrical signal. The analog electrical signal output from the image sensor 808 is converted into a digital signal by a not-illustrated analog-to-digital (A/D) converter, then subjected to predetermined image processing by a not-illustrated image processing circuit, and stored as image data (video data) in a storage medium such as a not-illustrated semiconductor memory.

The imaging apparatus main body 820 also includes, as internal components, a gyro sensor 801 that detects the amount of camera shake (vibration) in the vertical direction (pitching) and a gyro sensor 802 that detects the amount of camera shake (vibration) in the horizontal direction (yawing). The coreless motors 804 and 805 are driven in directions opposite to those of the vibrations detected by the gyro sensors 801 and 802, whereby the optical axis of the camera shake correction optical system 803 extending in a Z direction is vibrated. As a result, the vibration of the optical axis due to the camera shake is cancelled out, and camera shake-corrected favorable images can be captured.

The vibration actuator 200 is driven by the control method described in one of the foregoing first to fourth exemplary embodiments, and drives the focus lens 807 that is an optical member disposed in the lens barrel 810 in the optical axis direction (Z direction) via the gear 240. The focus lens 807 is not restrictive, and the vibration actuator 200 can be used to drive any lens, such as a zoom lens (not illustrated).

A driving circuit 809 including the control apparatus 100 and the position detection unit 300 illustrated in FIGS. 3 and 4 is built in the imaging apparatus main body 820.

While the fifth exemplary embodiment is described to be applied to the imaging apparatus 800 as an example of the electronic device including the vibration driving apparatus 10 according to the foregoing first, second, third, or fourth exemplary embodiment, the present disclosure is not limited to the imaging apparatus 800. The present disclosure is widely applicable to electronic apparatuses equipped with a member that needs to be positioned by the driving of the vibration actuator 200. In the fifth exemplary embodiment, the vibration driving apparatus 10 can also be used to drive the image sensor 808 on which the light passed through the lenses forms an image, or drive the camera shake correction optical system 803.

### Other Exemplary Embodiments

The present disclosure can also be implemented by processing for supplying a program for implementing one or more functions of the foregoing exemplary embodiments to a system or an apparatus via a network or a storage medium, and reading and executing the program by one or more processors in a computer of the system or apparatus. A circuit that implements one or more of the functions (such as an ASIC) can also be used for implementation.

This program and a computer-readable storage medium storing the program are included in the present disclosure.

The foregoing exemplary embodiments of the present disclosure are all merely examples of embodiments for carrying out the present disclosure, and are not to be interpreted as limiting the technical scope of the present disclosure. In other words, the present disclosure can be practiced in various forms without departing from the technical concept or main features thereof.

The disclosure of the exemplary embodiments of the present disclosure includes the following configurations and methods.

### Configuration 1

A control apparatus of a vibration actuator including a vibrating body and a contact body, the vibrating body including an electrical-mechanical energy transducer, the contact body being configured to contact the vibrating body, the vibrating body and the contact body being moved relative to each other by vibration generated by applying an alternating-current signal to the electrical-mechanical energy transducer, the control apparatus comprising:

control means for, in a case where a first value that is a value concerning a relative speed between the vibrating body and the contact body and obtained by subtracting a current value from a command value generated to approach a target value is positive at a specific time during acceleration of the vibration actuator, performing control to decrease a frequency of the alternating-current signal or control to increase an effective voltage of the alternating-current signal, and in a case where the first value is other than positive, performing control of the frequency of the alternating-current signal or control of the effective voltage of the alternating-current signal that is performed at a time prior to the specific time.

### Configuration 2

The control apparatus of the vibration actuator according to Configuration 1, wherein the control means, in a case where a second value that is a value concerning a relative position between the vibrating body and the contact body and obtained by subtracting a current value from a command value is positive at the specific time during the acceleration of the vibration actuator, performs the control to decrease the frequency of the alternating-current signal or the control to increase the effective voltage of the alternating-current signal, and in a case where the second value is other than positive, performs the control of the frequency of the alternating-current signal or the control of the effective voltage of the alternating-current signal that is performed at the time prior to the specific time.

### Configuration 3

The control apparatus of the vibration actuator according to Configuration 1 or 2, wherein the control means, in a case where a third value that is a value concerning a relative acceleration between the vibrating body and the contact body and obtained by subtracting a current value from a threshold is positive at the specific time during the acceleration of the vibration actuator, performs the control to decrease the frequency of the alternating-current signal or the control to increase the effective voltage of the alternating-current signal, and in a case where the third value is other than positive, performs the control of the frequency of the alternating-current signal or the control of the effective voltage of the alternating-current signal that is performed at the time prior to the specific time.

### Configuration 4

The control apparatus of the vibration actuator according to any one of Configurations 1 to 3, wherein when the current value of the relative speed reaches the target value, the control means performs control to change at least one of the frequency of the alternating-current signal and the effective voltage of the alternating-current signal based on a deviation between the command value and the current value concerning a position or speed of the vibration actuator.

### Configuration 5

The control apparatus of the vibration actuator according to any one of Configurations 1 to 4, wherein in a case where the current value of the relative speed is 0, the control means sets an amount of change over time in the frequency of the alternating-current signal during the control to decrease the frequency of the alternating-current signal or an amount of change over time in the effective voltage of the alternating-current signal during the control to increase the effective voltage of the alternating-current signal to be greater than an amount of change in a case where the current value is positive.

### Configuration 6

The control apparatus of the vibration actuator according to any one of Configurations 1 to 5, wherein in a case where the current value of the relative speed is negative, the control means sets an amount of change over time in the frequency of the alternating-current signal during the control to decrease the frequency of the alternating-current signal or an amount of change over time in the effective voltage of the alternating-current signal during the control to increase the effective voltage of the alternating-current signal to be greater than an amount of change in a case where the current value is 0.

### Configuration 7

A control apparatus of a vibration actuator including a vibrating body and a contact body, the vibrating body including an electrical-mechanical energy transducer, the contact body being configured to contact the vibrating body, the vibrating body and the contact body being moved relative to each other by vibration generated by applying an alternating-current signal to the electrical-mechanical energy transducer, the control apparatus comprising:

control means for, in a case where a first value that is a value concerning a relative speed between the vibrating body and the contact body and obtained by subtracting a current value from a command value generated to approach a target value is positive at a specific time during deceleration of the vibration actuator, performing control to increase a frequency of the alternating-current signal or control to decrease an effective voltage of the alternating-current signal, and in a case where the first value is other than positive, performing control of the frequency of the alternating-current signal or control of the effective voltage of the alternating-current signal that is performed at a time prior to the specific time.

### Configuration 8

The control apparatus of the vibration actuator according to Configuration 7, wherein the control means, in a case where a second value that is a value concerning a relative position between the vibrating body and the contact body and obtained by subtracting a current value from a command value is positive at the specific time during the deceleration of the vibration actuator, performs the control to increase the frequency of the alternating-current signal or the control to decrease the effective voltage of the alternating-current signal, and in a case where the second value is other than positive, performs the control of the frequency of the alternating-current signal or the control of the effective voltage of the alternating-current signal that is performed at the time prior to the specific time.

### Configuration 9

The control apparatus of the vibration actuator according to Configuration 7 or 8, wherein the control means, in a case where a third value that is a value concerning a relative acceleration between the vibrating body and the contact body and obtained by subtracting a current value from a threshold is positive at the specific time during the deceleration of the vibration actuator, performs the control to increase the frequency of the alternating-current signal or the control to decrease the effective voltage of the alternating-current signal, and in a case where the third value is other than positive, performs the control of the frequency of the alternating-current signal or the control of the effective voltage of the alternating-current signal that is performed at the time prior to the specific time.

### Configuration 10

A control apparatus of a vibration actuator including a vibrating body and a contact body, the vibrating body including an electrical-mechanical energy transducer, the contact body being configured to contact the vibrating body, the vibrating body and the contact body being moved relative to each other by vibration generated by applying an alternating-current signal to the electrical-mechanical energy transducer, the control apparatus comprising:

control means for, in a case where a first value that is a value concerning a relative speed between the vibrating body and the contact body and obtained by subtracting a current value from a command value generated to approach a target value is positive at a specific time during acceleration of the vibration actuator, performing control to decrease a frequency of the alternating-current signal or control to increase a phase difference of the alternating-current signal, and in a case where the first value is other than positive, performing control of the frequency of the alternating-current signal or control of the phase difference of the alternating-current signal that is performed at a time prior to the specific time.

### Configuration 11

The control apparatus of the vibration actuator according to Configuration 10, wherein the control means, in a case where a second value that is a value concerning a relative position between the vibrating body and the contact body and obtained by subtracting a current value from a command value is positive at the specific time during the acceleration of the vibration actuator, performs the control to decrease the frequency of the alternating-current signal or the control to increase the phase difference of the alternating-current signal, and in a case where the second value is other than positive, performs the control of the frequency of the alternating-current signal or the control of the phase difference of the alternating-current signal that is performed at the time prior to the specific time.

### Configuration 12

The control apparatus of the vibration actuator according to Configuration 10 or 11, wherein the control means, in a case where a third value that is a value concerning a relative acceleration between the vibrating body and the contact body and obtained by subtracting a current value from a threshold is positive at the specific time during the acceleration of the vibration actuator, performs the control to decrease the frequency of the alternating-current signal or the control to increase the phase difference of the alternating-current signal, and in a case where the third value is other than positive, performs the control of the frequency of the alternating-current signal or the control of the phase difference of the alternating-current signal that is performed at the time prior to the specific time.

### Configuration 13

The control apparatus of the vibration actuator according to any one of Configurations 10 to 12, wherein when the current value of the relative speed reaches the target value, the control means performs control to change at least one of the frequency of the alternating-current signal and the phase difference of the alternating-current signal based on a deviation between the command value and the current value concerning a position or speed of the vibration actuator.

### Configuration 14

The control apparatus of the vibration actuator according to any one of Configurations 10 to 13, wherein in a case where the current value of the relative speed is 0, the control means sets an amount of change over time in the frequency of the alternating-current signal during the control to decrease the frequency of the alternating-current signal or an amount of change over time in the phase difference of the alternating-current signal during the control to increase the phase difference of the alternating-current signal to be greater than an amount of change in a case where the current value is positive.

### Configuration 15

The control apparatus of the vibration actuator according to any one of Configurations 10 to 14, wherein in a case where the current value of the relative speed is negative, the control means sets an amount of change over time in the frequency of the alternating-current signal during the control to decrease the frequency of the alternating-current signal or an amount of change over time in the phase difference of the alternating-current signal during the control to increase the phase difference of the alternating-current signal to be greater than an amount of change in a case where the current value is 0.

### Configuration 16

A control apparatus of a vibration actuator including a vibrating body and a contact body, the vibrating body including an electrical-mechanical energy transducer, the contact body being configured to contact the vibrating body, the vibrating body and the contact body being moved relative to each other by vibration generated by applying an alternating-current signal to the electrical-mechanical energy transducer, the control apparatus comprising:

control means for, in a case where a first value that is a value concerning a relative speed between the vibrating body and the contact body and obtained by subtracting a current value from a command value generated to approach a target value is positive at a specific time during deceleration of the vibration actuator, performing control to increase a frequency of the alternating-current signal or control to decrease a phase difference of the alternating-current signal, and in a case where the first value is other than positive, performing control of the frequency of the alternating-current signal or control of the phase difference of the alternating-current signal that is performed at a time prior to the specific time.

### Configuration 17

The control apparatus of the vibration actuator according to Configuration 16, wherein the control means, in a case where a second value that is a value concerning a relative position between the vibrating body and the contact body and obtained by subtracting a current value from a command value is positive at the specific time during the deceleration of the vibration actuator, performs the control to increase the frequency of the alternating-current signal or the control to decrease the phase difference of the alternating-current signal, and in a case where the second value is other than positive, performs the control of the frequency of the alternating-current signal or the control of the phase difference of the alternating-current signal that is performed at the time prior to the specific time.

### Configuration 18

The control apparatus of the vibration actuator according to Configuration 16 or 17, wherein the control means, in a case where a third value that is a value concerning a relative acceleration between the vibrating body and the contact body and obtained by subtracting a current value from a threshold is positive at the specific time during the deceleration of the vibration actuator, performs the control to increase the frequency of the alternating-current signal or the control to decrease the phase difference of the alternating-current signal, and in a case where the third value is other than positive, performs the control of the frequency of the alternating-current signal or the control of the phase difference of the alternating-current signal that is performed at the time prior to the specific time.

### Configuration 19

A driving apparatus comprising:
the control apparatus of the vibration actuator according to any one of Configurations 1 to 18;
the vibration actuator; and
a position detection unit configured to detect position information corresponding to a/the relative position between the vibrating body and the contact body.

### Configuration 20

An electronic device comprising:
the driving apparatus according to Configuration 19; and
a member to be driven by the vibration actuator.

### Method 1

A control method for a vibration actuator including a vibrating body and a contact body, the vibrating body including an electrical-mechanical energy transducer, the contact body being configured to contact the vibrating body, the vibrating body and the contact body being moved relative to each other by vibration generated by applying an alternating-current signal to the electrical-mechanical energy transducer, the control method comprising:
a control step of, in a case where a first value that is a value concerning a relative speed between the vibrating body and the contact body and obtained by subtracting a current value from a command value generated to approach a target value is positive at a specific time during acceleration of the vibration actuator, performing control to decrease a frequency of the alternating-current signal or control to increase an effective voltage of the alternating-current signal, and in a case where the first value is other than positive, performing control of the frequency of the alternating-current signal or control of the effective voltage of the alternating-current signal that is performed at a time prior to the specific time.

### Method 2

A control method for a vibration actuator including a vibrating body and a contact body, the vibrating body including an electrical-mechanical energy transducer, the contact body being configured to contact the vibrating body, the vibrating body and the contact body being moved relative to each other by vibration generated by applying an alternating-current signal to the electrical-mechanical energy transducer, the control method comprising:
a control step of, in a case where a first value that is a value concerning a relative speed between the vibrating body and the contact body and obtained by subtracting a current value from a command value generated to approach a target value is positive at a specific time during deceleration of the vibration actuator, performing control to increase a frequency of the alternating-current signal or control to decrease an effective voltage of the alternating-current signal, and in a case where the first value is other than positive, performing control of the frequency of the alternating-current signal or control of the effective voltage of the alternating-current signal that is performed at a time prior to the specific time.

### Method 3

A control method for a vibration actuator including a vibrating body and a contact body, the vibrating body including an electrical-mechanical energy transducer, the contact body being configured to contact the vibrating body, the vibrating body and the contact body being moved relative to each other by vibration generated by applying an alternating-current signal to the electrical-mechanical energy transducer, the control method comprising:
a control step of, in a case where a first value that is a value concerning a relative speed between the vibrating body and the contact body and obtained by subtracting a current value from a command value generated to approach a target value is positive at a specific time during acceleration of the vibration actuator, performing control to decrease a frequency of the alternating-current signal or control to increase a phase difference of the alternating-current signal, and in a case where the first value is other than positive, performing control of the frequency of the alternating-current signal or control of the phase difference of the alternating-current signal that is performed at a time prior to the specific time.

### Method 4

A control method for a vibration actuator including a vibrating body and a contact body, the vibrating body including an electrical-mechanical energy transducer, the contact body being configured to contact the vibrating body, the vibrating body and the contact body being moved relative to each other by vibration generated by applying an alternating-current signal to the electrical-mechanical energy transducer, the control method comprising:
a control step of, in a case where a first value that is a value concerning a relative speed between the vibrating body and the contact body and obtained by subtracting a current value from a command value generated to approach a target value is positive at a specific time during deceleration of the vibration actuator, performing control to increase a frequency of the alternating-current signal or control to decrease a phase difference of the alternating-current signal, and in a case where the first value is other than positive, performing control of the frequency of the alternating-current signal or control of the phase difference of the alternating-current signal that is performed at a time prior to the specific time.

The present disclosure is not limited to the above-described exemplary embodiments, and various modifications and variations can be made without departing from the spirit and scope of the present disclosure.

According to the present disclosure, unstable driving of a driving target by a vibration actuator can be prevented, and driving noise of the vibration actuator can be reduced.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

1. A control apparatus of a vibration actuator including a vibrating body and a contact body, the vibrating body including an electrical-mechanical energy transducer, the contact body being configured to contact the vibrating body, the vibrating body and the contact body being moved relative to each other by vibration generated in the vibrating body, the control apparatus comprising:
control means for, in a case where a first value that is a value concerning a relative speed between the vibrating body and the contact body and obtained by subtracting a current value from a command value generated to approach a target value is positive at a specific time during acceleration of the vibration actuator, performing control to decrease a frequency of the alternating-current signal or control to increase an effective voltage of the alternating-current signal, and in a case where the first value is other than positive, performing control of the frequency of the alternating-current signal or control of the effective voltage of the alternating-current signal that is performed at a time prior to the specific time.

2. The control apparatus of the vibration actuator according to claim 1, wherein the control means, in a case where a second value that is a value concerning a relative position between the vibrating body and the contact body and obtained by subtracting a current value from a command value is positive at the specific time during the acceleration of the vibration actuator, performs the control to decrease the frequency of the alternating-current signal or the control to increase the effective voltage of the alternating-current signal, and in a case where the second value is other than positive, performs the control of the frequency of the alternating-current signal or the control of the effective voltage of the alternating-current signal that is performed at the time prior to the specific time.

3. The control apparatus of the vibration actuator according to claim 1, wherein the control means, in a case where a third value that is a value concerning a relative acceleration between the vibrating body and the contact body and obtained by subtracting a current value from a threshold is positive at the specific time during the acceleration of the vibration actuator, performs the control to decrease the frequency of the alternating-current signal or the control to increase the effective voltage of the alternating-current signal, and in a case where the third value is other than positive, performs the control of the frequency of the alternating-current signal or the control of the effective voltage of the alternating-current signal that is performed at the time prior to the specific time.

4. The control apparatus of the vibration actuator according to claim 1, wherein when the current value of the relative speed reaches the target value, the control means performs control to change at least one of the frequency of the alternating-current signal and the effective voltage of the alternating-current signal based on a deviation between the command value and the current value concerning a position or speed of the vibration actuator.

5. The control apparatus of the vibration actuator according to claim 1, wherein in a case where the current value of the relative speed is 0, the control means sets an amount of change over time in the frequency of the alternating-current signal during the control to decrease the frequency of the alternating-current signal or an amount of change over time in the effective voltage of the alternating-current signal during the control to increase the effective voltage of the alternating-current signal to be greater than an amount of change in a case where the current value is positive.

6. The control apparatus of the vibration actuator according to claim 1, wherein in a case where the current value of the relative speed is negative, the control means sets an amount of change over time in the frequency of the alternating-current signal during the control to decrease the frequency of the alternating-current signal or an amount of change over time in the effective voltage of the alternating-current signal during the control to increase the effective voltage of the alternating-current signal to be greater than an amount of change in a case where the current value is 0.

7. A control apparatus of a vibration actuator including a vibrating body and a contact body, the vibrating body including an electrical-mechanical energy transducer, the contact body being configured to contact the vibrating body, the vibrating body and the contact body being moved relative to each other by vibration generated in the vibrating body, the control apparatus comprising:
control means for, in a case where a first value that is a value concerning a relative speed between the vibrating body and the contact body and obtained by subtracting a current value from a command value generated to approach a target value is positive at a specific time during deceleration of the vibration actuator, performing control to increase a frequency of the alternating-current signal or control to decrease an effective voltage of the alternating-current signal, and in a case where the first value is other than positive, performing control of the frequency of the alternating-current signal or control of the effective voltage of the alternating-current signal that is performed at a time prior to the specific time.

8. The control apparatus of the vibration actuator according to claim 7, wherein the control means, in a case where a second value that is a value concerning a relative position between the vibrating body and the contact body and obtained by subtracting a current value from a command value is positive at the specific time during the deceleration of the vibration actuator, performs the control to increase the frequency of the alternating-current signal or the control to decrease the effective voltage of the alternating-current signal, and in a case where the second value is other than positive, performs the control of the frequency of the alternating-current signal or the control of the effective voltage of the alternating-current signal that is performed at the time prior to the specific time.

9. The control apparatus of the vibration actuator according to claim 7, wherein the control means, in a case where a third value that is a value concerning a relative acceleration between the vibrating body and the contact body and obtained by subtracting a current value from a threshold is positive at the specific time during the deceleration of the vibration actuator, performs the control to increase the frequency of the alternating-current signal or the control to decrease the effective voltage of the alternating-current signal, and in a case where the third value is other than positive, performs the control of the frequency of the alternating-current signal or the control of the effective voltage of the alternating-current signal that is performed at the time prior to the specific time.

10. A control apparatus of a vibration actuator including a vibrating body and a contact body, the vibrating body including an electrical-mechanical energy transducer, the contact body being configured to contact the vibrating body, the vibrating body and the contact body being moved relative to each other by vibration generated in the vibrating body, the control apparatus comprising:
control means for, in a case where a first value that is a value concerning a relative speed between the vibrating body and the contact body and obtained by subtracting a current value from a command value generated to approach a target value is positive at a specific time during acceleration of the vibration actuator, performing control to decrease a frequency of the alternating-current signal or control to increase a phase difference of the alternating-current signal, and in a case where the first value is other than positive, performing control of the frequency of the alternating-current signal or control of the phase difference of the alternating-current signal that is performed at a time prior to the specific time.

11. The control apparatus of the vibration actuator according to claim 10, wherein the control means, in a case where a second value that is a value concerning a relative position between the vibrating body and the contact body and obtained by subtracting a current value from a command value is positive at the specific time during the acceleration of the vibration actuator, performs the control to decrease the frequency of the alternating-current signal or the control to increase the phase difference of the alternating-current signal, and in a case where the second value is other than positive, performs the control of the frequency of the alternating-current signal or the control of the phase difference of the alternating-current signal that is performed at the time prior to the specific time.

12. The control apparatus of the vibration actuator according to claim 10, wherein the control means, in a case where a third value that is a value concerning a relative acceleration between the vibrating body and the contact body and obtained by subtracting a current value from a threshold is positive at the specific time during the acceleration of the vibration actuator, performs the control to decrease the frequency of the alternating-current signal or the control to increase the phase difference of the alternating-current signal, and in a case where the third value is other than positive, performs the control of the frequency of the alternating-current signal or the control of the phase difference of the alternating-current signal that is performed at the time prior to the specific time.

13. The control apparatus of the vibration actuator according to claim 10, wherein when the current value of the relative speed reaches the target value, the control means performs control to change at least one of the frequency of the alternating-current signal and the phase difference of the alternating-current signal based on a deviation between the command value and the current value concerning a position or speed of the vibration actuator.

14. The control apparatus of the vibration actuator according to claim 10, wherein in a case where the current value of the relative speed is 0, the control means sets an amount of change over time in the frequency of the alternating-current signal during the control to decrease the frequency of the alternating-current signal or an amount of change over time in the phase difference of the alternating-current signal during the control to increase the phase difference of the alternating-current signal to be greater than an amount of change in a case where the current value is positive.

15. The control apparatus of the vibration actuator according to claim 10, wherein in a case where the current value of the relative speed is negative, the control means sets an amount of change over time in the frequency of the alternating-current signal during the control to decrease the frequency of the alternating-current signal or an amount of change over time in the phase difference of the alternating-current signal during the control to increase the phase difference of the alternating-current signal to be greater than an amount of change in a case where the current value is 0.

16. A control apparatus of a vibration actuator including a vibrating body and a contact body, the vibrating body including an electrical-mechanical energy transducer, the contact body being configured to contact the vibrating body, the vibrating body and the contact body being moved relative to each other by vibration generated in the vibrating body, the control apparatus comprising:
control means for, in a case where a first value that is a value concerning a relative speed between the vibrating body and the contact body and obtained by subtracting a current value from a command value generated to approach a target value is positive at a specific time during deceleration of the vibration actuator, performing control to increase a frequency of the alternating-current signal or control to decrease a phase difference of the alternating-current signal, and in a case where the first value is other than positive, performing control of the frequency of the alternating-current signal or control of the phase difference of the alternating-current signal that is performed at a time prior to the specific time.

17. The control apparatus of the vibration actuator according to claim 16, wherein the control means, in a case where a second value that is a value concerning a relative position between the vibrating body and the contact body and obtained by subtracting a current value from a command value is positive at the specific time during the deceleration of the vibration actuator, performs the control to increase the frequency of the alternating-current signal or the control to decrease the phase difference of the alternating-current signal, and in a case where the second value is other than positive, performs the control of the frequency of the alternating-current signal or the control of the phase difference of the alternating-current signal that is performed at the time prior to the specific time.

18. The control apparatus of the vibration actuator according to claim 16, wherein the control means, in a case where a third value that is a value concerning a relative acceleration between the vibrating body and the contact body and obtained by subtracting a current value from a threshold is positive at the specific time during the deceleration of the vibration actuator, performs the control to increase the frequency of the alternating-current signal or the control to decrease the phase difference of the alternating-current signal, and in a case where the third value is other than positive, performs the control of the frequency of the alternating-current signal or the control of the phase difference of the alternating-current signal that is performed at the time prior to the specific time.

19. A driving apparatus comprising:
the control apparatus of the vibration actuator according to claim 1;
the vibration actuator; and
a position detection unit configured to detect position information corresponding to a/the relative position between the vibrating body and the contact body.

20. An electronic device comprising:
the driving apparatus according to claim 19; and
a member to be driven by the vibration actuator.

21. A control method for a vibration actuator including a vibrating body and a contact body, the vibrating body including an electrical-mechanical energy transducer, the contact body being configured to contact the vibrating body, the vibrating body and the contact body being moved relative to each other by vibration generated in the vibrating body, the control method comprising:
a control step of, in a case where a first value that is a value concerning a relative speed between the vibrating body and the contact body and obtained by subtracting a current value from a command value generated to approach a target value is positive at a specific time during acceleration of the vibration actuator, performing control to decrease a frequency of the alternating-current signal or control to increase an effective voltage of the alternating-current signal, and in a case where the first value is other than positive, performing control of the frequency of the alternating-current signal or control of the effective voltage of the alternating-current signal that is performed at a time prior to the specific time.

22. A control method for a vibration actuator including a vibrating body and a contact body, the vibrating body including an electrical-mechanical energy transducer, the contact body being configured to contact the vibrating body, the vibrating body and the contact body being moved relative to each other by vibration generated in the vibrating body, the control method comprising:
a control step of, in a case where a first value that is a value concerning a relative speed between the vibrating body and the contact body and obtained by subtracting a current value from a command value generated to approach a target value is positive at a specific time during deceleration of the vibration actuator, performing control to increase a frequency of the alternating-current signal or control to decrease an effective voltage of the alternating-current signal, and in a case where the first value is other than positive, performing control of the frequency of the alternating-current signal or control of the effective voltage of the alternating-current signal that is performed at a time prior to the specific time.

23. A control method for a vibration actuator including a vibrating body and a contact body, the vibrating body including an electrical-mechanical energy transducer, the contact body being configured to contact the vibrating body, the vibrating body and the contact body being moved relative to each other by vibration generated in the vibrating body, the control method comprising:
a control step of, in a case where a first value that is a value concerning a relative speed between the vibrating body and the contact body and obtained by subtracting a current value from a command value generated to approach a target value is positive at a specific time during acceleration of the vibration actuator, performing control to decrease a frequency of the alternating-current signal or control to increase a phase difference of the alternating-current signal, and in a case where the first value is other than positive, performing control of the frequency of the alternating-current signal or control of the phase difference of the alternating-current signal that is performed at a time prior to the specific time.

24. A control method for a vibration actuator including a vibrating body and a contact body, the vibrating body including an electrical-mechanical energy transducer, the contact body being configured to contact the vibrating body, the vibrating body and the contact body being moved relative to each other by vibration generated in the vibrating body, the control method comprising:
a control step of, in a case where a first value that is a value concerning a relative speed between the vibrating body and the contact body and obtained by subtracting a current value from a command value generated to approach a target value is positive at a specific time during deceleration of the vibration actuator, performing control to increase a frequency of the alternating-current signal or control to decrease a phase difference of the alternating-current signal, and in a case where the first value is other than positive, performing control of the frequency of the alternating-current signal or control of the phase difference of the alternating-current signal that is performed at a time prior to the specific time.
